(19) United States
(12) Patent Application Publication
(10) Pub. No.: US 2002/0010611 A1
(43) Pub. Date: Jan. 24, 2002

(54) Order taking apparatus, order taking method, storage medium, and program

(76) Inventors: Yoshihisa Yamaji, Kanagawa (JP); Takayuki Nagatsuka, Kanagawa (JP); Yukihiko Shimizu, Chiba (JP); Rikio Shiba, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/866,666

(22) Filed: May 30, 2001

(30) Foreign Application Priority Data
May 30, 2000 (JP) 161043 / 2000
May 25, 2001 (JP) 157650 / 2001

(51) Int. Cl. G06F 17/60

(52) U.S. Cl. 705/8

(57) ABSTRACT

On designated dates from customers for sales of articles, a collecting request of used items for recycling, or the like through the Internet, and a service is added and the designated dates from the customers are concentrated on a specific date, thereby enabling trucks for delivery or collection for recycling to be efficiently used.

### BACKGROUND OF THE INVENTION

1. Field of the Invention

The invention relates to an order taking apparatus, an order taking method, a storage medium, and a program for receiving various requests such as order making for an article, collection of an article for recycling, and the like from a terminal of a customer through a communication line.

2. Related Background Art

Hitherto, order making for a purchase article or the like has been performed by using a telephone, a facsimile apparatus, or the like. When a date of delivery of the purchase article is designated by the customer on the telephone, a deliverer of the article performs a delivery work on the basis of the designation of the date of delivery from the customer.

Also in case of a collecting request (order making) of an article for recycling, a method whereby a requestor designates a date of collection of the article for recycling by using a telephone, a facsimile, or the like in a manner similar to the order making for an article which is newly purchased is used. A collector (person who manages a truck) collects the article for recycling in accordance with the designation from the requestor.

However, when the orders for delivery and collecting requests for recycling are received in accordance with desire of the customers, there is a case where a variation occurs in the dates of delivery of articles, that is, transportation routes by which the deliverer runs the delivery trucks, dates/time zones of the transportation, and the like. A problem such that the efficient delivery work cannot be performed occurs. For example, if the number of articles to be delivered is small, some of a plurality of trucks for delivery do not operate or an ability of the truck cannot be sufficiently utilized. If the dates of delivery are concentrated on the same day, the number of orders has to be suppressed. Even if there are a plurality of customers whose places of delivery are close to each other, if the dates of delivery of the customers differ, the deliverer has to run the truck to the same area many times. On the other hand, if the dates of delivery of the customers whose places of delivery are far from each other are set to the same day, even if the number of articles to be delivered is small, the deliverer has to run the truck for a long time. Therefore, the costs for transportation of the articles rise, resulting in an increase in price of the article.

Also with respect to the requests for collection (order making) of articles for recycling, similarly, if a variation occurs in the request days, request places, or the like of collection of the articles for recycling, the efficient collecting work for recycling, that is, the efficient run of the trucks for collection for recycling cannot be performed. The transport charges for collection for recycling rise, resulting in an increase in costs for collection for recycling. On the manufacturer side, it causes a situation such that the costs for collection for recycling have to be reflected to a price of the sales article. Consequently, it obstructs a promotion of purchase by the customers.

On the other hand, with respect to the collection of articles for recycling, it is needless to say that it is very important to collect the used articles for recycling and recycle and reuse them when considering an environment of the earth. However, it is very costly to actually collect the used articles for recycling. It becomes a cause of obstruction to the promotion of collection for recycling of the customers, for example, in a mechanism such that the customer side bears the collecting costs for recycling. On the other hand, also on the collector's side who collects the used articles for recycling, since the collecting costs for recycling are high, profitability as business is not satisfied, so that it becomes a cause of obstruction to the collecting work for recycling.

### SUMMARY OF THE INVENTION

The invention is made to individually or collectively solve the foregoing problems and it is an object of the invention to provide a method whereby a person who orders various requests is allowed to freely input order contents and it is possible to provide articles, services, or collecting services for recycling which are advantageous and cheaper to the customer side, supplier side, and deliverer side.

To accomplish the above object, according to the invention, there is provided an order taking apparatus for receiving request information such as order making for articles, request for collection of used articles for recycling, and the like from a plurality of order making terminals, comprising: information processing means for setting order taking conditions for the designated data such as date of delivery of the article, date of collection of a collection article for recycling, and the like and changing the order taking conditions in accordance with request situations from the plurality of order making terminals; and communicating means for communicating information with the order making terminals.

The above and other objects and features of the present invention will become apparent from the following detailed description and the appended claims with reference to the accompanying drawings.

### BRIEF DESCRIPTION OF THE DRAWINGS

FIG. 1 is a diagram showing a whole system construction using an order taking system of the invention;

FIG. 2 is a diagram showing a construction of an order taking server, an order making terminal, and a bid making terminal which construct the order taking system of the invention;

FIG. 3 is a diagram showing an example of tables which are defined in a database of a system according to the first embodiment of the invention;

FIG. 4 is a diagram showing a flow for processes of the order taking server, processes of the order making terminal, and processes between them according to the first embodiment of the invention;

FIG. 5 is a diagram showing an example of an article selection picture plane according to the first embodiment of the invention;

FIG. 6 is a diagram showing an example of a customer ID input picture plane, a customer information display picture plane, and a service content display picture plane according to the first embodiment of the invention;

FIG. 7 is a diagram showing an example of a delivery place selection picture plane according to the first embodiment of the invention;

FIG. 8 is a diagram showing an example of an order making picture plane according to the first embodiment of the invention;

FIG. 9 is a diagram showing an example of an order making picture plane according to the first embodiment of the invention;

FIG. 10 is a diagram showing an example of an order making picture plane according to the first embodiment of the invention;

FIG. 11 is a diagram showing an example of a picture plane for automatically informing of a change in additional services according to the first embodiment of the invention;

FIG. 12 is a diagram showing a graph of an order status according to the first embodiment of the invention;

FIG. 13 is a diagram showing an example of a picture plane for automatically selecting a service designation according to the first embodiment of the invention;

FIG. 14 is a diagram showing a flow of data obtained after the customer decided the date of delivery of an article in the first embodiment of the invention;

FIG. 15 is a diagram showing an example of picture planes which are displayed on a terminal of a deliverer in the first embodiment of the invention;

FIG. 16 is a diagram showing an example of an order making picture plane according to the second embodiment of the invention;

FIG. 17 is a diagram showing an example of an order making picture plane according to the third embodiment of the invention;

FIG. 18 is a diagram showing an example of tables which are defined in a database of a system according to the fourth embodiment of the invention;

FIG. 19 is a diagram showing a flow for processes of the order taking server, processes of the order making terminal, and processes between them according to the fourth embodiment of the invention;

FIG. 20 is a diagram showing an example of a customer ID input picture plane, a customer information display picture plane, and a service content display picture plane according to the fourth embodiment of the invention; and

FIG. 21 is a diagram showing an example of a requesting picture plane according to the fourth embodiment of the invention.

### DETAILED DESCRIPTION OF THE PREFERRED EMBODIMENTS

Embodiments of the invention will now be described in detail hereinbelow with reference to the drawings.

### First Embodiment

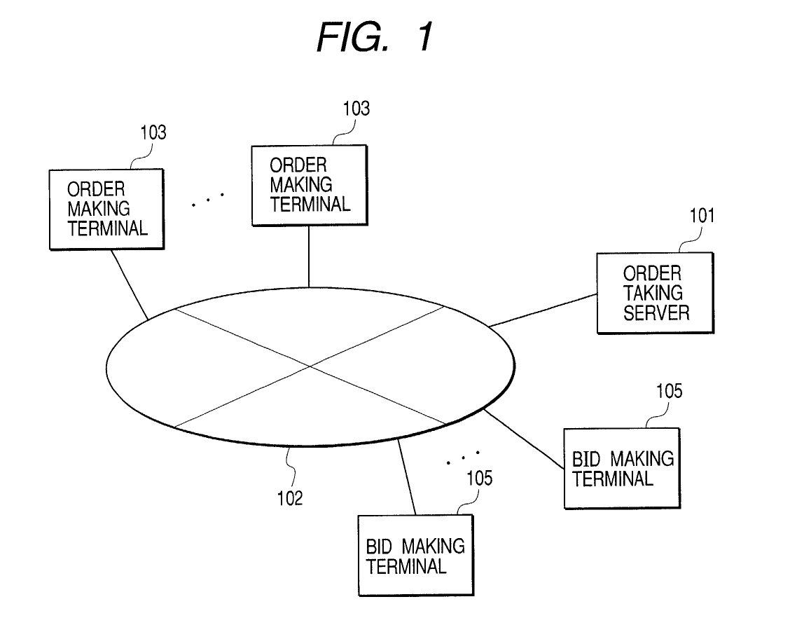

FIG. 1 shows a whole system construction using an order taking system of the invention.

In FIG. 1, reference numeral 101 denotes an order taking server for receiving orders for products from order making terminals 103 through a communication network. The order taking server 101 functions as an order taking system of the invention. Reference numeral 103 denotes the order making terminals by which the users order products. Reference numeral 105 denotes bid making terminals each for making a bid with respect to a delivery work of the order article which the order taking server 101 received. The order making terminals 103 and bid making terminals 105 are together called clients. Reference numeral 102 denotes a communication network such as Internet or the like.

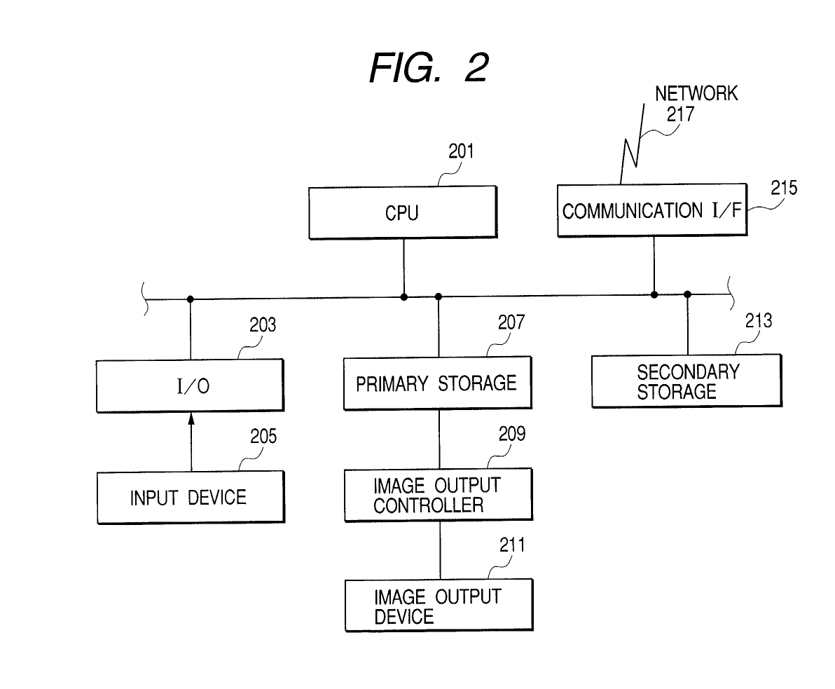

FIG. 2 shows an example of a construction of the order taking server 101 in FIG. 1. Each of the order making terminals 103 and bid making terminals 105 can be also constructed in a manner similar to the order taking server 101. The order taking server 101 has: an input/output interface (I/O) 203; an operation processing unit (CPU or MPU) 201; an input device 205; a primary storage 207; a secondary storage 213; an image output controller 209; an image output device 211; and a communication interface 215. The I/O interface 203 transfers input data from the input device 205, which will be explained hereinlater, to the CPU 201.

The communication I/F 215 performs an output of data to a terminal apparatus and a transmission of data to the terminal apparatus. The communication I/F 215 is a communication interface for communicating with an external apparatus through a communicating circuit (network) 217 (LAN or WAN), for example, in accordance with a protocol such as TCP/IP (Transmission Control Protocol/Internet Protocol), HTTP (HyperText Transfer Protocol) of its upper layer, or the like and functions as communicating means of the invention.

The operation processing unit (CPU or MPU) 201 executes a control of an information processing system and the whole system according to the invention based on program codes stored in a primary storage on a secondary storage which will be explained later, and operates as information processing means of the invention.

A pointing device such as keyboard or mouse or the like can be used as an input device 205. By the input device 205, the operation is instructed and data which is used for arithmetic operating processes is inputted to the CPU 201.

The primary storage 207 has an ROM and an RAM and primarily stores input/output data to/from the CPU 201 and data to be displayed. A DMA controller can be used as an image output controller 209. The image output controller 209 reads out the data to be displayed from the primary storage 207 and transfers it to the image output device 211.

A printer or a display can be used as an image output device 211. The use of the display is presumed in the embodiment.

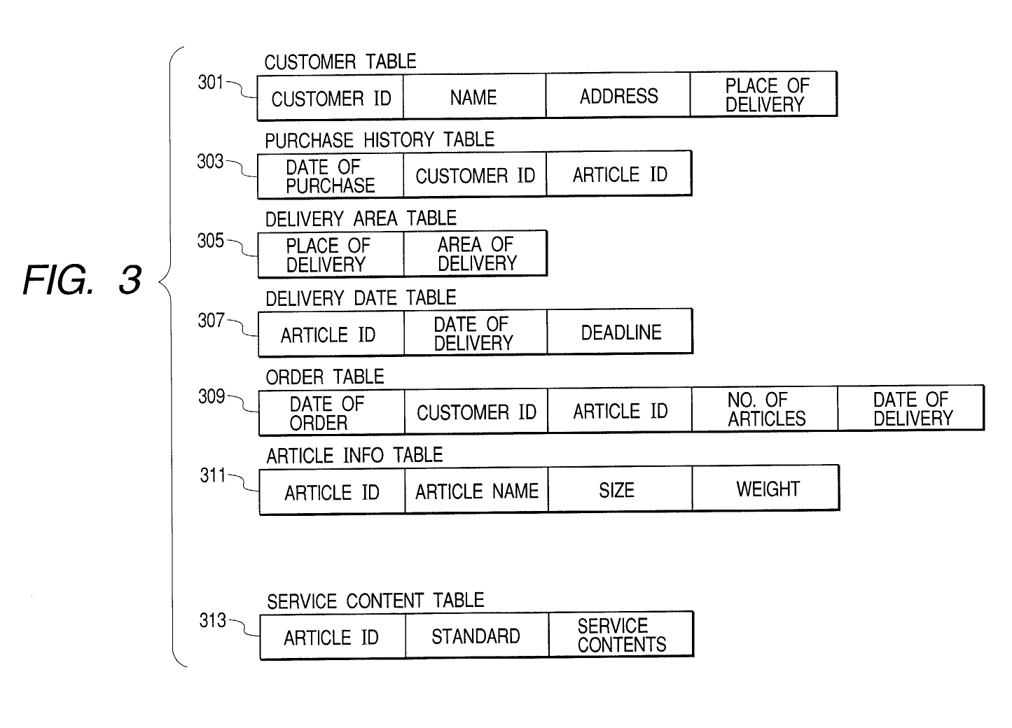

A hard disk device can be used as a secondary storage 213. The secondary storage 213 stores various programs which are executed by the CPU. The secondary storage 213 and primary storage 207 function as storage units of the invention. A database is constructed in the secondary storage 213. Data regarding the delivery of articles, for example, data such as article names, providing compensation information (discount rate of the article and additional services such as discount of a delivery fee, a free delivery fee, and the like), deadline date/time of acceptance of an order, and the like is registered into the database. FIG. 3 shows an example of tables which are defined in the database.

In FIG. 3, reference numeral 301 denotes a customer table for registering information necessary upon registration of the customer who joins the order taking system, that is, a name of the customer, an ID (customer ID) that is peculiar to the customer, and an address and a delivery destination (place of delivery). Reference numeral 303 denotes a purchase history table in which the purchased articles and the customer IDs have been registered. Reference numeral 305 denotes a delivery area table in which the delivery destination and delivery area are associated with each other. The delivery area corresponding to the delivery address information designated from the order making terminal 103 is determined by the order taking server 101 by using the delivery area table. Reference numeral 307 denotes a delivery date table in which the delivery date and deadline for the article have been defined. It is assumed that the delivery date in the invention indicates a date (time) when the truck which runs to deliver or collect the article goes to the customer address. Reference numeral 309 denotes an order table in which the ordered articles, the number of articles, and the delivery date designated by the customer are registered. Reference numeral 311 denotes an article information table in which information such as name, size, and the like of the article corresponding to an article ID has been made to correspond. As for the article ID, it is unnecessary to make one ID correspond to one article. For example, even in case of the same kind of articles, if colors of main bodies are different, a different article ID can be also allocated to the article every different color.

Reference numeral 313 denotes a service content table in which order taking conditions (service contents) responsive to the order for the article are registered. Besides those information, delivery ability information and the like of the deliverer have been registered in the database. “Delivery ability information” may indicates the weight or volume of articles that can be loaded on a truck. The delivery ability information is stored and managed in a storage unit of the order taking server 101 for each deliverer. This information is used to determine the amount or volume of articles to be loaded on a truck for delivery or collection so as to get the most efficient truck operation. According to loading condition for the most efficient truck operation, it is possible to provide customers with more advantageous order conditions, such as article order making conditions or collection request conditions, in the present embodiment.

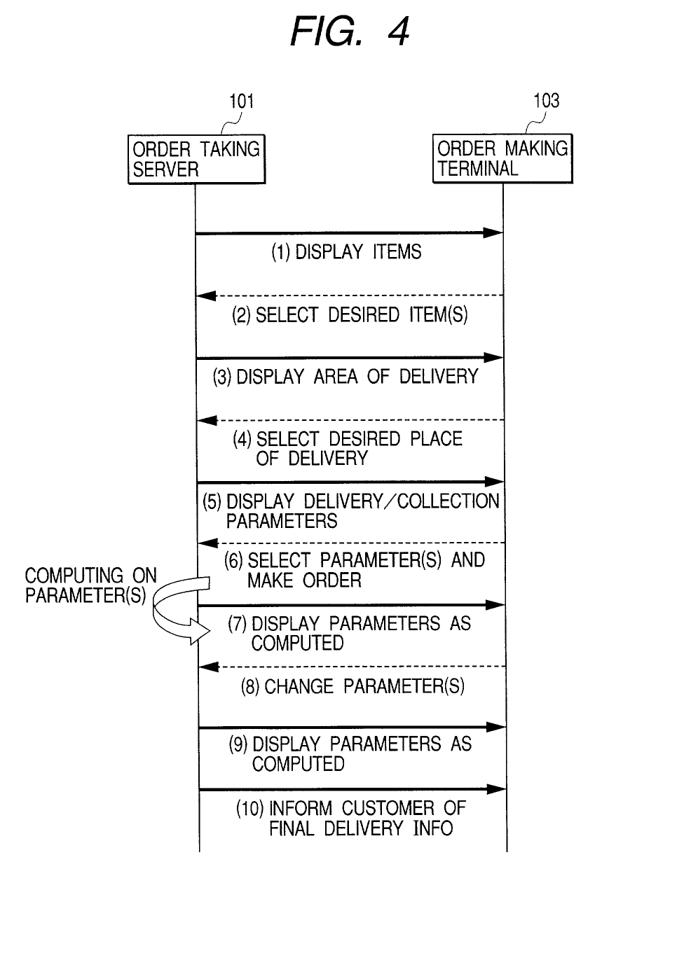

The information which is transferred between the order taking server 101 and order making terminal 103 and the system operation will be described with reference to FIG. 4. It is assumed that each process which will be explained hereinbelow is realized by a method whereby the CPU provided in one main apparatus (the order taking server 101 or order making terminal 103) executes processes based on program codes stored in a non-volatile storage unit.

In FIG. 4, when the customer accesses to the order taking server 101 from the order making terminal 103 through the network, the order taking server 101 displays an item (articles as targets of delivery; and parts are also included) selection picture plane by which an article can be searched and selected (step (1)). When the customer selects a desired item from the item selection picture plane (step (2)), areas of delivery which can be selected by the customer are displayed together with detailed information including a specification explanation for the selected item (step (3)).

The customer selects a desired place of delivery from the displayed areas (step (4)). When the place of delivery is selected, an order picture plane including a list of delivery information limited to the selected place of delivery is displayed (step (5)). The delivery information includes items such as date of delivery, deadline for order, current order status (the total number of ordered items), additional services, and the like. Each item included in the delivery information is hereinafter called a parameter.

The customer can make an order for delivery from the order picture plane. When there is an order from the customer (step (6)), the order taking server 101 computes the total number of ordered items and the additional services which can be provided on the basis of the parameters included in the order information. After that, when the customer accesses to the order taking server 101, the computed parameters are displayed on the screen of the order making terminal 103 of the customer (step (7)) and notified to the customer. The customer collates the computed result and can further change the order contents (step (8)). The order taking server 101 further computes additional services or the like on the basis of the changed parameters (step (9)).

When the date of delivery reaches the deadline date/time, the parameters of the delivery information are determined and the customer who registered the delivery corresponding to the relevant deadline date/time is informed of the final delivery information (step (10)).

A flow of the system will now be described hereinbelow on the basis of the relation with the display picture planes which are provided from the order taking server 101.

To inform the deliverer of the desired date/time of delivery of the purchased article, the customer accesses to the order taking server 101 from the order making terminal 103. The access to the order taking server 101 is made by linking from the order taking terminal 101 to a site for providing information or, in the case where the order taking server 101 is a server of WWW (World Wide Web) and the picture plane to display the order information is a hyper picture plane described by the HTML (HyperText Markup Language), such an access is made by a method whereby an address of the server is designated in a URL (Uniform Resource Locator) format.

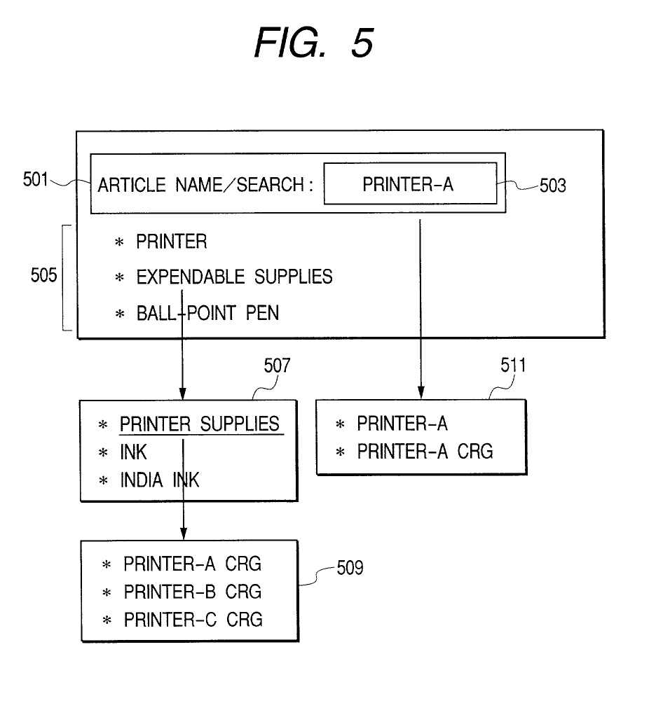

FIG. 5 shows an example of an item selection picture plane which is displayed in the case where when there is the access from the customer through the order making terminal 103, the order taking server 101 transmits the display information to the order making terminal 103 through a predetermined communication line (Internet line), so that the display information is displayed on a display portion of the order making terminal 103.

As shown in FIG. 5, an article decision/search column 501 and an item 505 are displayed on the item selection picture plane. An article name input portion 503 in which characters can be inputted is included in the article search column 501. In the embodiment, since article codes have been allocated to all of the articles so that a category (for example, each article included in “expendable supplies”) can be distinguished, the customer can select a desired item 505 by clicking it by a drill-down operation by using the pointing device (input device 205 in FIG. 2) connected to the order making terminal 103. The “drill-down” in the embodiment denotes an operating method on the screen whereby the order taking server limits and displays a selection range step by step on the display screen in order of KANTO→KANAGAWA→KAWASAKI-CITY, thereby allowing the customer to select a desired item while gradually narrowing the selection range.

For example, when the article name input portion 503 is held as a blank column and the portion of a character train “expendable supplies” is clicked in the displayed item 505, a detailed item, that is, an item 507 such as printer supplies, ink, India ink, etc. is displayed. By selecting and clicking a character train “printer supplies” from the item on the picture plane 507, a more detailed item 509 is displayed.

When the customer inputs an article name and a search word into the article name input portion 503, the item to be displayed can be limited. For example, like an example of FIG. 5, when a specific article name of a character train “printer-A” is inputted into the article name input portion 503, the item which is displayed is changed from 505 to 511. The printer-A, a cartridge (CRG) for the printer-A, and the like are displayed on the picture plane. The character train which can be inputted into the article name input portion 503 is not limited to the article name but a search word or the like can be also inputted.

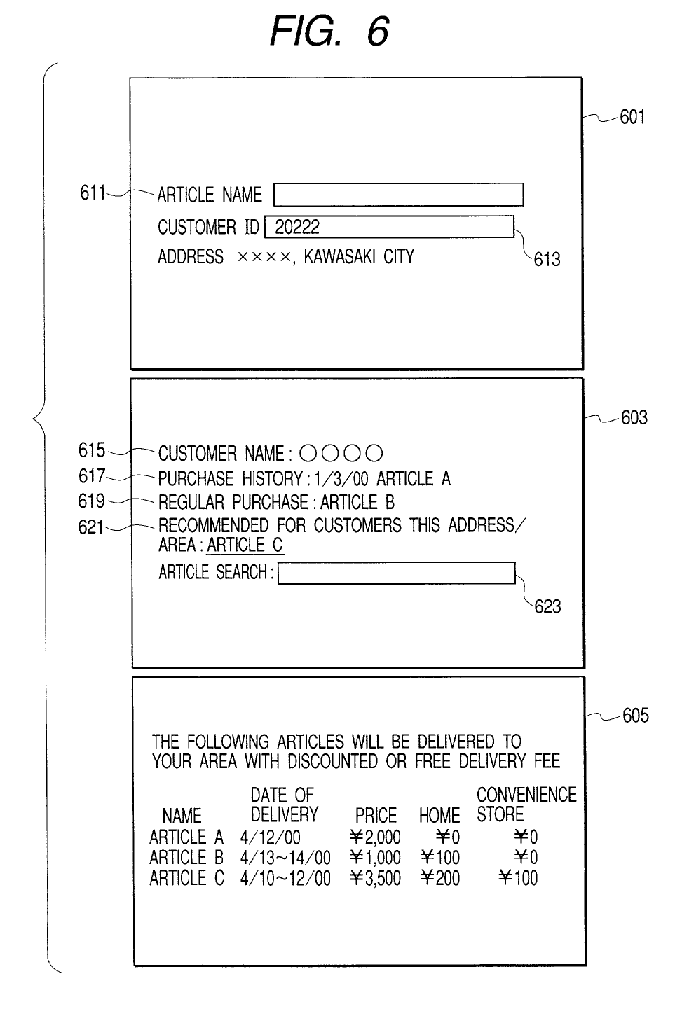

FIG. 6 shows a picture plane which is displayed at the order making terminal 103 of the customer after the item was designated on the item selection picture plane showing the example in FIG. 5. The order taking server 101 displays a customer ID input picture plane 601 including a column for inputting information such as customer ID, address of the customer, and the like onto the picture plane. On the picture plane, an article (item) name selected on the item display picture plane is displayed in an article name display portion 611. The customer inputs his own ID allocated from the deliverer into a customer ID input portion 613.

After completion of the input, a customer information display picture plane 603 corresponding to the inputted customer ID is transmitted from the order taking server 101 to the order making terminal 103 through a predetermined communication line and displayed on the display portion of the order making terminal 103 which received the transmitted information (customer information display picture plane 603). Reference numeral 615 denotes a customer name display column for displaying the name of the customer derived from the customer table 301. Reference numeral 617 denotes a purchase history display column for displaying an article purchase history of the customer on the basis of the purchase history table 303. Reference numeral 619 denotes a display column of a regular article which the customer purchases every time.

Reference numeral 621 denotes a recommended article display column for displaying an article whose purchase is recommended to the customer on the basis of articles of a limited area and data of the other customers. In this column, there are displayed names of the articles which are determined by the order taking server 101 in a manner such that if the customer purchases the article from the articles which he purchased in the past with reference to the purchase history table 303 in the database, services which are more advantageous to the customer than the usual services can be provided to the customer. The CPU 201 for making a decision as mentioned above functions as information processing means. In the example of FIG. 6, the customer purchases an article A on Jan. 3, 2000, and the regular article which is often purchased is an article B, and an article whose purchase is recommended to the customer is an article C.

When the customer clicks a portion of an article name “ARTICLE C”, the order taking server 101 determines services to the customer by computation on the basis of the delivery data of the other customers whose addresses are located in an area where the customer lives. For example, when a customer B intends to make an order for a desired article, the order taking server 101 refers to the customer table 301, delivery area table 305, order table 309, and service content table 313. When it is confirmed that a customer A whose delivery area is the same as that of the customer B has already made an order for delivery, it is possible to make a decision indicating that the services are executed in the case where the date of delivery designated by the customer B and that designated by the customer A coincide. As another process, the service contents to the customer can be also computed on the basis of a delivery efficiency, purchase history data of the customer, and the like. The CPU 201 for automatically computing the order taking conditions with respect to each of the order making terminals of the customers as mentioned above corresponds to the information processing means of the invention.

Reference numeral 605 denotes an example of a service content display picture plane which is displayed after completion of the above computation. In the embodiment, if a delivery schedule to the other customer address is located in the area where the customer lives, a computation for making a delivery fee free of charge or discounting it is executed and a result of the computation is displayed on the service content display picture plane 605.

Besides the above display method, the order taking server 101 can also display services to the customer on a date of delivery which will be convenient to the supplier side or the like onto the service content display picture plane 605 or can provide them to the customer. On the basis of the information, the customer can select the article to be purchased.

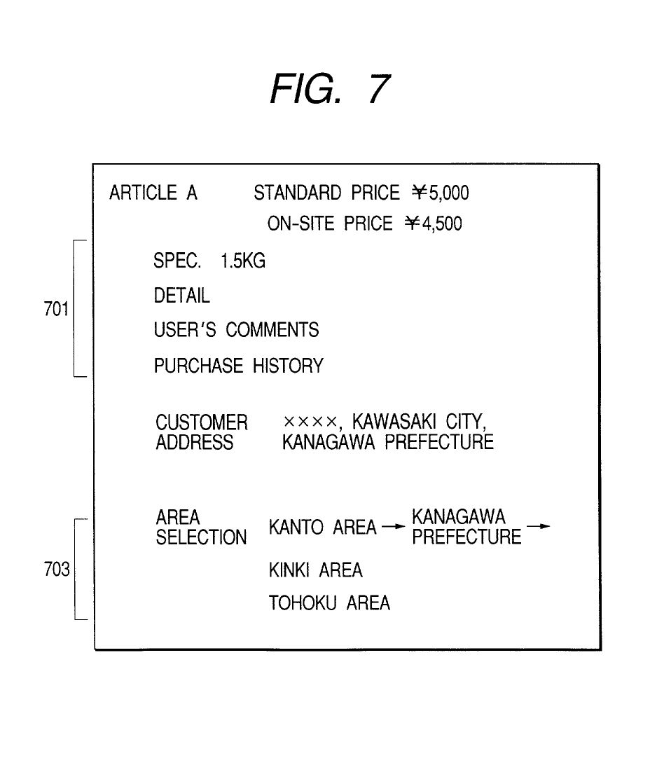

FIG. 7 shows an example of a delivery place selection picture plane which is displayed on the customer information display picture plane 603 in the case where the article name to be searched is inputted into an article search column 623.

In the embodiment, as information 701 of the article selected by the customer, the order taking server 101 transmits the following information to the terminal apparatus 103 on the customer side through the communication I/F 215: that is, a standard price of the article; a standard price on the site; a detailed explanation regarding the article; a comment of the customer to the article; a purchase history regarding the article of the customer which accessed to the server; and the like. The picture plane displayed on the basis of the transmitted data is displayed on the terminal apparatus 103. The customer collates each article by this picture plane, decides the article to be purchased, and selects the place of delivery from an area selection column 703 on the picture plane for the article to be purchased. The customer can select the address of the customer or the area where the address is located from this column by the drill-down. For example, if the customer first selects the KANTO area, items to be selected next by the customer are narrowed down only to Tokyo-to, Hokkaido, and all of the prefectures of the KANTO area. For example, in the embodiment, KANAGAWA prefecture is selected from them.

In the embodiment, the area is selected by a method of selecting the area displayed on the screen. However, the area can be selected by inputting the place of delivery by a character train or can be also selected by a method whereby a map or the like is displayed on the screen of the terminal apparatus and the customer selects the area from the map by using the pointing device such as a mouse or the like.

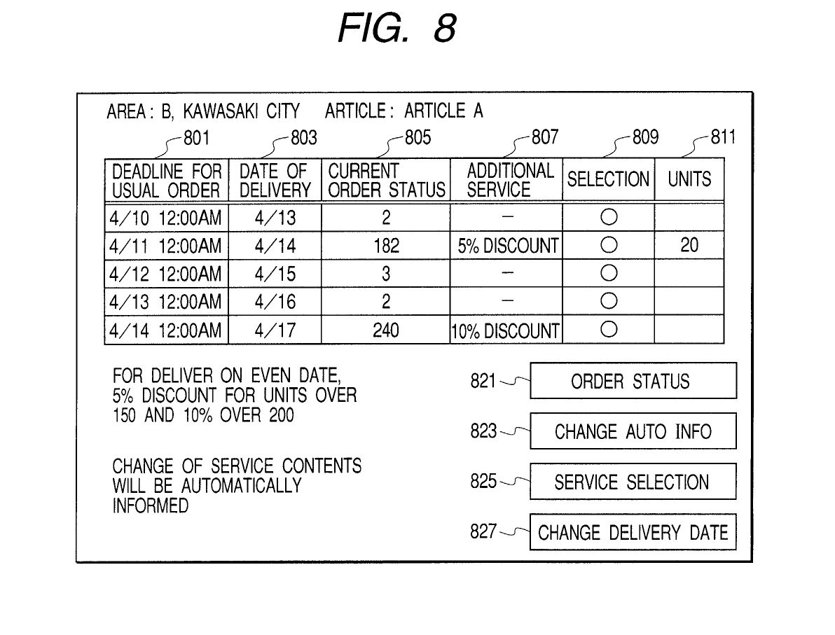

FIG. 8 shows an example of an order picture plane which is transmitted from the communication I/F 215 of the order taking server 101 as communicating means and displayed when the customer selects the place of delivery.

Reference numeral 821 denotes an order status graphics button for displaying a current order status 805 by a bar graph; 823 a change auto info button for allowing the customer to change an automatic informing format; 825 a service selection button for displaying a service designation automatic selection picture plane; and 827 a change delivery date button for changing later the date of delivery of the article which the customer has already ordered.

The order taking server 101 displays a situation of a certain desired delivery area including the place of delivery of the customer as shown in FIG. 8 on the basis of the article delivery place data of the customer, base station data of the deliverer, size/weight data of the article, and the like. A list regarding the current order status and order taking conditions regarding the desired article is displayed on the above picture plane. There are considered an effect such that the customer can easily see the display screen, an effect such that the concentration of deliveries to certain month/day is promoted, and the like by a method of displaying only the deadline for usual order in which the additional services (providing compensation) such as a discount rate and he like shown in the list of FIG. 8 are set to the conditions which are advantageous to the customer or a method of rearranging the additional services in order from the advantageous service. The above list is formed by the CPU 201 of the order taking server 101 which operates as information processing means.

Reference numeral 801 denotes a display column of a deadline for usual order for displaying a deadline for the usual order for the article; 803 a date of delivery display column for displaying a date of delivery of the article A corresponding to the deadline; 805 the order status display column showing the current order status (the total number of ordered articles) of the article A; 807 an additional service display column for the customer in the case where the article A has been ordered; 809 a delivery date selection button; and 811 a units input column for inputting the number of articles to be ordered. When the customer executes an order making process, he depresses the selection button 809 corresponding to a desired date of delivery. After the units input column 811 as parameters which can be changed was enabled to be inputted, the customer inputs the number of articles A to be purchased. The order taking server 101 automatically computes a change in service contents on the basis of the delivery date and the number of articles which were selected by the customer.

In the embodiment, the service contents for the order for the article are determined by comparing the total number of specific articles which are delivered on a desired date, that is, the order status of the article with a predetermined standard value. If the total number of specific articles which are delivered on a desired date exceeds the predetermined standard value as a result of the comparison, the service contents are changed in the direction so as to become more advantageous to the customer. By more finely setting a plurality of standard values for changing the service contents, the service contents can be also changed step by step.

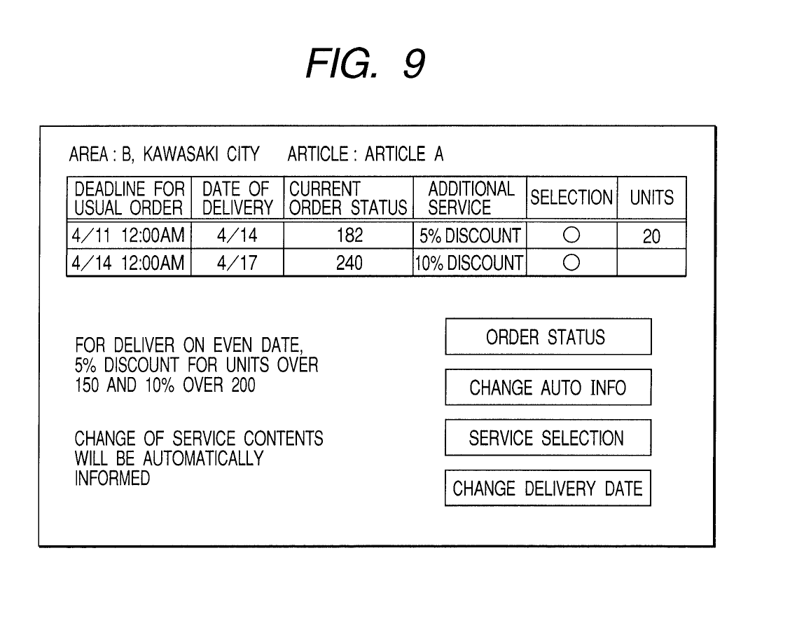

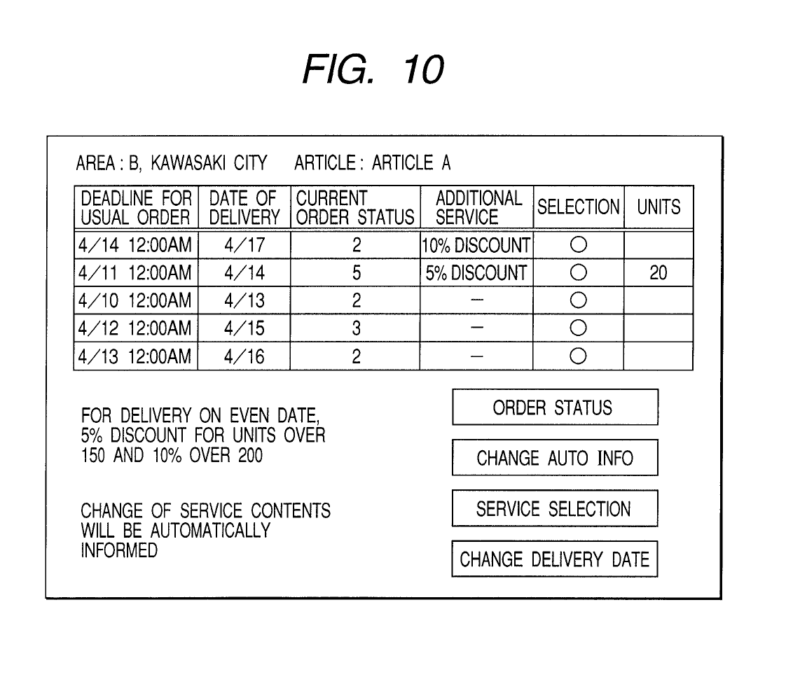

FIG. 9 shows an example of a display picture plane which is displayed on the terminal apparatus at an initial stage of the order status of the customer. For example, by presetting the additional services corresponding to 4/11 to “5% Discount”, the orders by the customers can be concentrated to this date. Further, as already described above, by raising the additional service (discount rate) in accordance with the order status, the concentration of the orders from the customers to a certain desired date can be promoted. As shown in FIG. 10, the additional services can be also displayed in order from the high service within a range where the deadline is not expired.

In the examples of FIGS. 8 to 10, when the number of articles A which will be delivered on even date exceeds 150, a 5% discount is performed with respect to the price of the article A and when the number of articles A exceeds 200, a 10% discount is performed. Therefore, in this example, if the date of delivery is designated to April 14 and 20 articles A are ordered, the value in the order status display column 805 is changed to 202 by adding 20 to 182 by an automatic computation of the server. Thus, since the total number of articles A exceeds 200, the value in the additional service display column 807 is changed from “5% Discount” to “10% Discount”. As mentioned above, the communication I/F 215 for transmitting the changed order taking conditions corresponds to the communicating means. Consequently, the 10% discount of the articles A which are delivered is executed to all of the customers who ordered the articles A by setting the date of delivery to April 14.

The contents of the new order status and additional services after completion of the automatic computation are displayed again on the order picture plane.

On the other hand, the customer who ordered the article A before the automatic change of the additional services cannot know a fact that the discount rate was changed unless the picture plane is collated after completion of the automatic change of the discount rate. Therefore, to the customer who desires the providing of change information, information to notify of a fact that the date of delivery is just before the deadline for the order making, and information such as final additional services or the like, the order making terminal 103 is automatically notified of the change information of the additional services from the order taking server 101 by E-mail or the like. The communication I/F 215 in the automatic notification operates as communicating means of the invention.

The customer can change the automatic informing format from the order making terminal 103 by depressing the change auto info button 823 on the order picture plane. After the depression of the change auto info button 823, the order taking server 101 displays options for automatic notification onto the screen of the customer, for example, displays options regarding the notifying format such as automatic notification of every change in service contents, automatic notification which is executed only when the discount rate changes by a predetermined value or more, automatic notification with respect to a change in providing compensation (the delivery fee is made free or the like) other than the discount or the providing of a new compensation, notification in the case where a more advantageous condition (discount rate) occurs on another date of delivery, non-notification of the service contents, non-notification regarding the information just before the deadline, non-notification of a final deadline, and the like. The customer selects one or more of the plurality of options, thereby applying for a change in automatic notifying format. The order taking server 101 which received the information regarding the change in automatic notification changes the automatic notifying format for the customer on the basis of this information. In this example, the communication I/F 215 which receives the information regarding the change in automatic notifying format and the CPU 201 for executing the process for changing the automatic notifying format every customer correspond to the communicating means and the information processing means of the invention, respectively.

An order to add an article and a new order by the customer can be usually performed until the deadline date/time of the order. The order taking server 101 makes an order for the article and decides the order taking conditions on the deadline. This deciding process is executed by the information processing means of the CPU 201.

The order taking process can be also closed even before the deadline for the order taking. For example, prior to starting the order taking process, the order taking server 101 determines the full number of order making persons in consideration of a range where the delivery work can be completed. The order taking process can be also closed when the number of order making persons is equal to the full number of persons. The invention is not limited to the full number of order making persons. It is presumed that the invention is also applied to a form such that the order taking process is closed in accordance with an order making quantity as a method of closing the order taking process.

The date of delivery of the article which has already been ordered can be also changed. By depressing the change delivery date button 827, only the information regarding the dates of delivery of the articles ordered by the customer is displayed in the list of the order picture plane. By subsequently depressing the delivery date selection button 809, the date displayed in the delivery date display column can be corrected. The customer corrects the displayed date, so that he can change the date of delivery.

The order making contents can be ordinarily changed by the customer until the deadline date/time of the order making process. The communication I/F 215 which operates as communicating means finishes the reception of the change information of the order making contents on the deadline. The CPU 201 of the order taking server 101 corresponding to the information processing means makes an order for the article and decides the order taking conditions on the deadline. Even after the usual deadline date/time, an order for a new article can be also accepted for a predetermined period of time by adding a condition such that the order making contents cannot be changed or the like. Since the order making change information which is transmitted from the order making terminal is accepted on a date that is predetermined days before the delivery date corresponding to the order taking conditions as mentioned above, the order can be accepted in consideration of the period of time with respect to the work after the deadline such as schedule of the delivery work, preparation of the delivery trucks, confirmation of the stocks, movement of the articles to a predetermined warehouse, and the like.

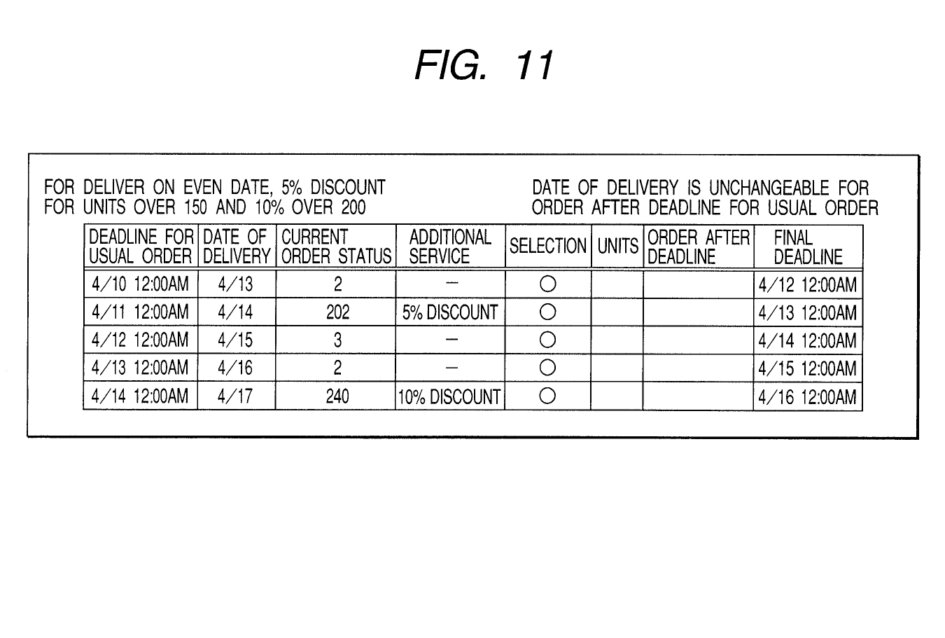

FIG. 11 shows an example of the contents which are notified to the order making terminal 103 from the order taking server 101 after the acceptance of the order on the date of delivery of April 14 was closed at 12:00 on April 11. A message indicating that there is a possibility that there is a benefit if the date of delivery is changed to April 14 is shown to the customer who desires the delivery on a day other than April 14. The delivery date information before and after the target delivery date is also included in report contents just before the deadline.

FIG. 12 shows an example of a picture plane which is displayed by the order taking server 101 when the order status graphics button 821 on the order picture plane is depressed. The information to display such a graph is formed by the CPU 201 of the order taking server 101 which operates as information processing means. After the information was formed, it is transmitted toward the order making terminal through a predetermined communication line by communicating means. In the example shown in FIG. 12, the current order status is shown by a bar graph and the additional services corresponding to the date of delivery are displayed.

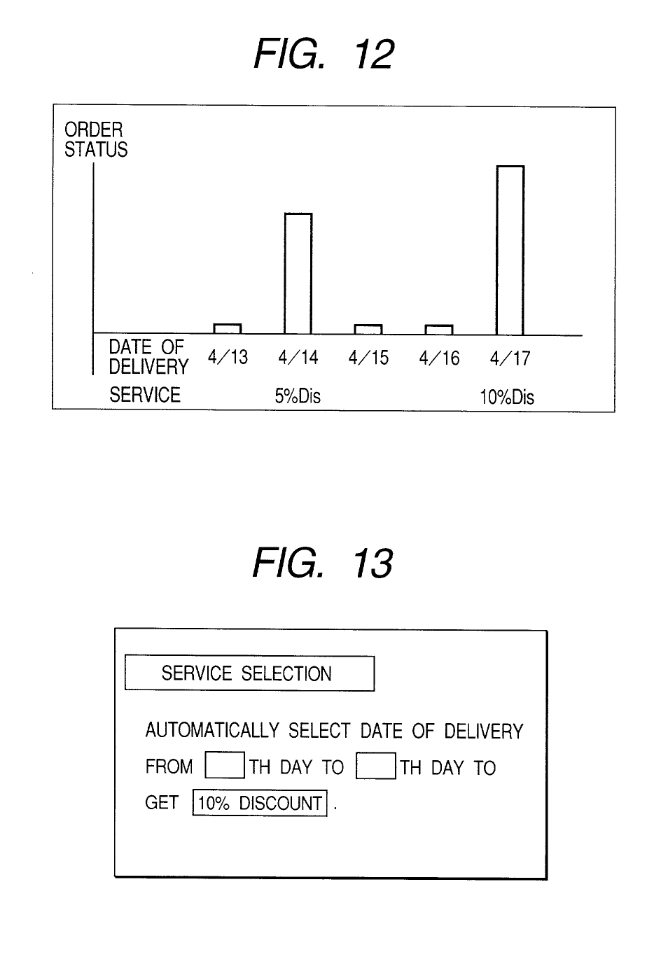

The order taking server 101 displays the service designation automatic selection picture plane when the service selection button 825 on the order picture plane is depressed. The processes regarding the display are executed on the basis of the transmission of the display information by the communicating means of the order taking server 101. FIG. 13 shows an example of this picture plane.

The customer inputs or selects a desired delivery date range and desired service contents (for example, 10% discount or the like) onto the screen of FIG. 13. This information is received by the communicating means of the order taking server 101. The CPU 201 of the order taking server 101 as information processing means automatically selects the date which satisfies the conditions of the designated services among the delivery dates within a predetermined desired period of time of the customer and registers the order making. As mentioned above, since the invention has a mechanism such that the services based on the desired delivery period of the customer and the compensation can be provided to the customer, the customer can omit a labor such that he confirms the order status by himself in order to obtain a desired service or the like.

Since the order taking conditions corresponding to a plurality of delivery dates (collection dates) are changed on the basis of the order statuses (collecting request statuses) from a plurality of order making terminals, even if the desired service of the customer does not exist at an order taking time point, in the case where the service which is matched with the desire of the customer is formed due to a change in request status after that, such a service can be provided, that is, notified to the customer.

If the providing service does not reach the desired service of the customer, it is also possible to select the delivery date on which the best service can be provided and the order can be made on the deadline date/time of the final delivery date. Even if the service does not reach the desired service of the customer, if there is a delivery date on which a service close to desired service of the customer, the order taking server 101 automatically notifies the terminal apparatus 103 of such a delivery date. The finally decided delivery date is automatically informed by E-mail or the like. As mentioned above, when there is not the service based on the desired delivery period and the desired compensation, the second service based on the delivery period is searched and provided to the customer. Therefore, even if there is not the service which perfectly satisfies the desire of the customer, the order taking provider can provide the service corresponding to it.

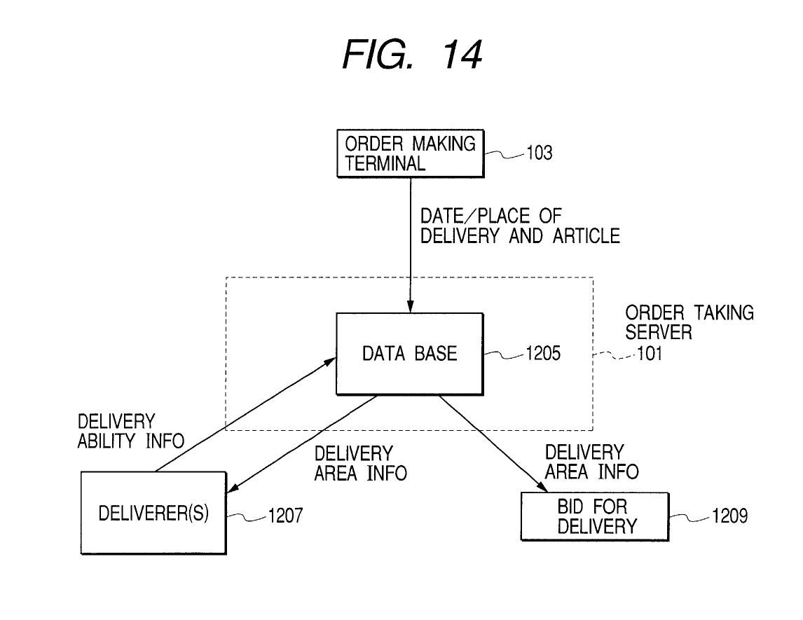

FIG. 14 shows a flow of data which is transmitted after the determination of the delivery date of the article purchased by the customer in the embodiment.

When the delivery date and the article name are provided from the customer to the order taking server 101, they are stored into a database 1205 of the order taking server 101. The CPU 201 which functions as information processing means forms information of the delivery work, that is, delivery area information or truck preparation schedule on the basis of the obtained information and delivery ability information which is provided from a deliverer 1207.

The delivery data or delivery schedule is distributed to the deliverer 1207 or, if a plurality of deliverers join the present system, it is used for a bit for delivery 1209.

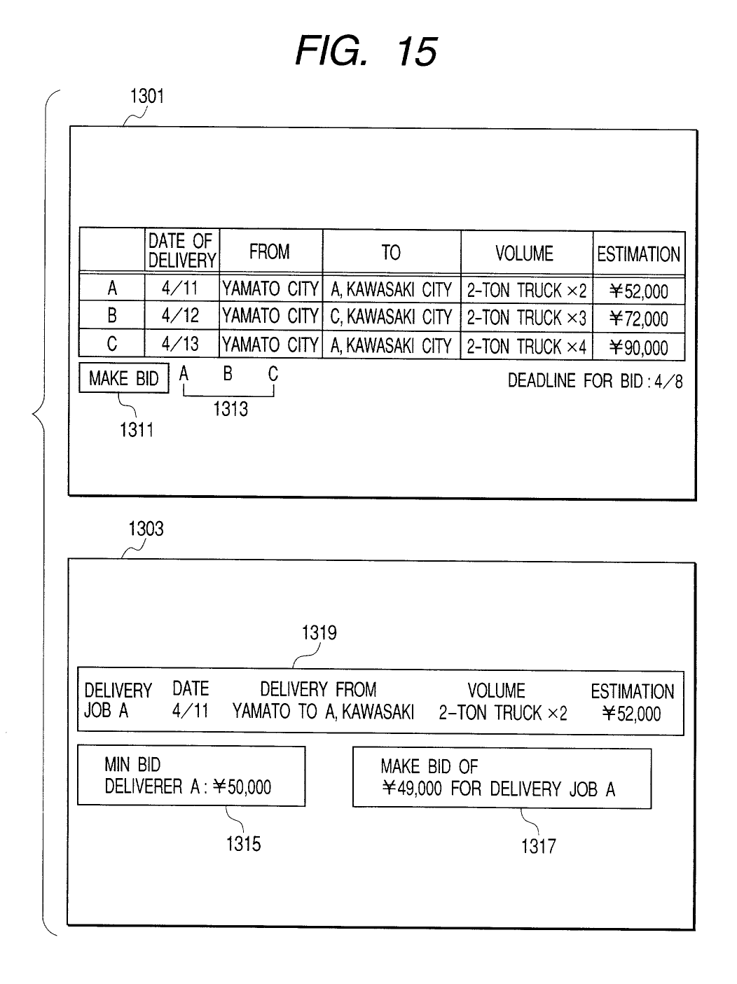

FIG. 15 shows a screen display state which is displayed on the display portion of the bid making terminal 105 of the deliverer by the order taking server 101 in case of performing a bid for delivery which is executed in the embodiment.

When the deliverer accesses to the order taking server 101 and inputs a password that is peculiar to the deliverer, the information of the delivery work formed by the CPU 201 corresponding to the information processing means of the invention is automatically displayed on the screen. In the example of FIG. 15, the information of the delivery work is constructed by a date of delivery, a delivery source (FROM), a delivery destination (TO), a volume, and a bid making scheduled price (estimation).

Among delivery works 1313 A to C listed on a delivery content collation picture plane 1301, when the delivery work A is selected as a desired delivery and a make bid button 1311 is clicked, a bid price input picture plane 1303 is displayed. The contents of the delivery work A are shown on the picture plane 1303. A minimum bid status obtained from the bid price inputted so far is displayed in a portion 1315. Reference numeral 1317 denotes a bid price input portion of the deliverer who depressed the make bid button 1311. The deliverer participates in the bid for delivery by inputting a desired price into the bid price input portion 1317.

The order taking server 101 collects the bid prices from the plurality of bid making terminals 105 through the network as mentioned above, compares the bid prices on a predetermined bid deadline, and can determine highest bid information such as deliverer which made a successful bid, highest bid price, and the like.

According to the embodiment as mentioned above, since the delivery work schedule information for delivering the articles is formed in accordance with the order status, not only the delivery work can be automatized but also the bid for delivery can be made on the basis of this information. Since this information has already been stored as electronic data, it can be used for a bid for delivery using the network.

In the embodiment, the CPU 201 as information processing means corresponds to means for deciding the highest bid information.

### Second Embodiment

In the above embodiment, the service contents for the order making have been determined by comparing the total number of desired articles to be delivered on a desired date with the predetermined standard value. However, in this comparing process, values other than the total number of articles, for example, the total value of sizes or weights of the articles included in the article information table 311 can be also compared with the standard value. The embodiment can be executed by a system constructed by the first embodiment.

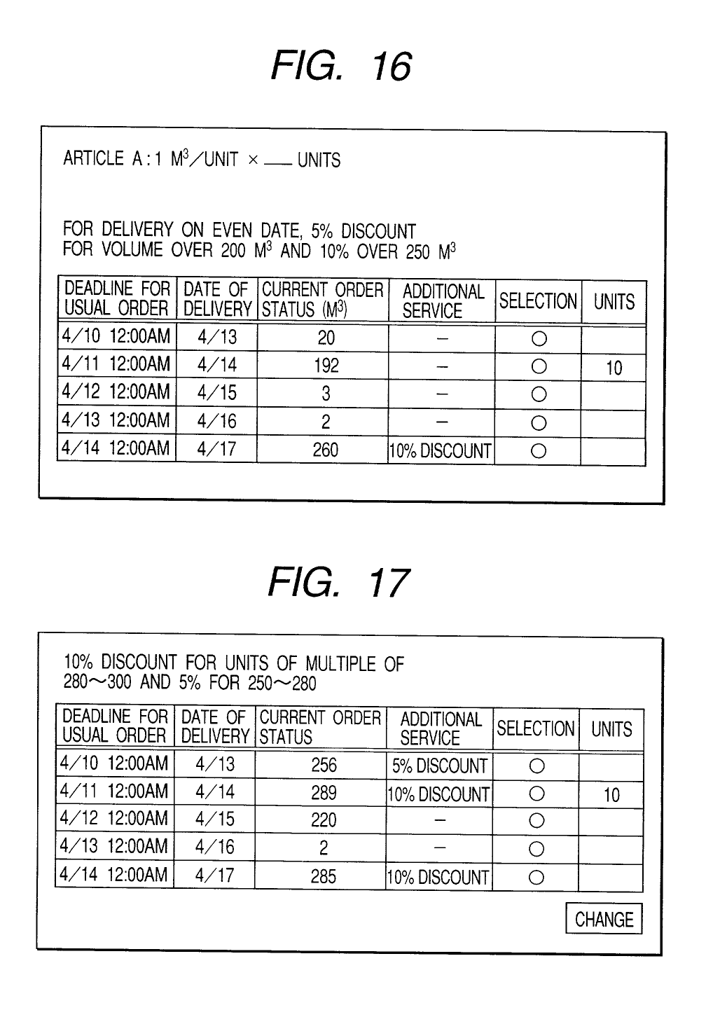

FIG. 16 is an example in which the current order status in the order picture plane is displayed by a size (cubic meter). In this example, the 5% discount is performed when the number of articles A which are delivered on an even date exceeds 200 cubic meter, and the 10% discount is performed when it exceeds 250 cubic meter. When the customer orders 10 articles A on the picture plane of FIG. 16, the size (1 cubic meter) of the article A×10=10 cubic meter is added to the order status of the delivery date of April 14. Therefore, a freight whose scheduled delivery date is April 14 is changed from 192 cubic meter to 202 cubic meter, and the 5% discount is made.

In the above embodiment, the information processing means of the CPU 201 corresponds to means for performing a computation for discount of the article.

### Third Embodiment

The system according to the invention can be also applied to not only the process for concentration of the delivery/collection dates/times but also a process for flattening the delivery/collection within a predetermined period of time. For example, if it becomes more advantageous to the deliverer by flattening the parcel delivery service, the system is constructed so as to provide conditions which will be more advantageous to the customer if it is flattened.

In a customer delivery/collection date/time flattening system as a system according to the embodiment, optimum constants are set for each date of parcel delivery/collection and displayed, and parameters are set so as to increase the discount rate as they approach the constants within a range where they do not exceed the optimum constants. Specifically speaking, assuming that the number of articles A which can be loaded per delivery truck is equal to 300, the highest services are executed when the total number of articles which are delivered is exactly equal to a multiple of 300. If the number of articles which are delivered is gradually increasing after the start of the order making, the service is added step by step until it reaches 300. It is fundamentally impossible to change the delivery date from the time point when the first additional service has been determined.

FIG. 17 shows an example of an order picture plane in the embodiment. In FIG. 17, the order taking server 101 displays the remaining number obtained by dividing the total number of articles by 300 onto the current order status 805.

With reference to the order status 805 of the delivery date before and after the desired delivery date, the customer can select the delivery date/time at which the discount rate will be changed to a larger rate after the order making and can input a quantity. When the order is made and the additional service is changed as mentioned above, the customer is automatically notified of the change information in a manner similar to the customer collecting/concentrating system.

Therefore, in the order taking server 101, by changing the additional service, the number of articles to be delivered on each delivery date is allowed to approach the multiple of 300 and the delivery work can be flattened. As another flattening method, if it is presumed that the number of orders from the customers is too large or small or the customer data on the system has a predetermined tendency or the like, the realization of such a flatness can be expected by designing the system so as to preliminarily change the additional service for the customers who satisfy certain order taking conditions. For example, a method of increasing the discount rate only on weekdays with respect to articles/services whose number of order making times is small on weekdays is considered. The realization of such a flatness can be also expected by limiting the additional services step by step for the customers who made up to a predetermined number of orders. For example, if there are articles to which he wants to set the number of providing times per day to about 300, by providing the high additional services to the customer in order of a range from the first order taking time to the 250th order taking time, a range from the 251st order taking time to the 300th order taking time, and a range from the 301st order taking time, it is possible to expect a situation such that the customer can avoid the order making on a day when he cannot obtain the high additional services in spite of a fact that he desires the higher additional services. The realization of the flatness can be expected even by this method.

### Fourth Embodiment

### Comparison Between the Whole System Diagram and the First Embodiment of the Information Processing Apparatus

The examples of the purchase request of the article mainly from the order making terminal 103 have been described as one order making form in the above embodiments. In the fourth embodiment, an example of a collecting request of the used articles or the like will now be described as an order making form from the customer.

First, a whole construction of the order taking system and a construction (corresponding to the order taking server 101, order making terminal 103, and bid making terminal 105) of the information processing apparatus in the embodiment will be described.

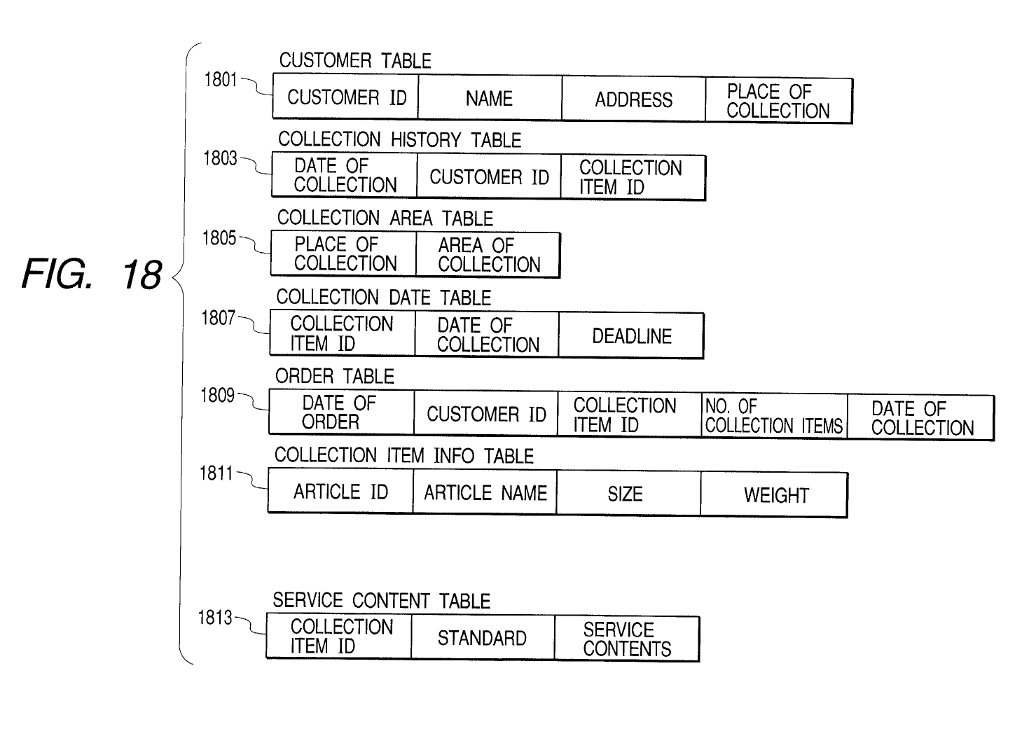

It is assumed that the whole construction of the order taking system and the construction of the information processing apparatus in the embodiment are fundamentally similar to the contents described in the first embodiment. The embodiment differs from the first embodiment with respect to the following points: that is, the portion corresponding to the terminal apparatus which is used by the deliverer who performs the delivery work of the truck for collecting collection items with respect to the bid making terminal in FIG. 1; a point that a database regarding the collection for recycling has been constructed in the secondary storage 213 in FIG. 2, for example, data such as names of collection items, providing compensation information (points for the collection for recycling, a discount of a collection fee, a free service of the collection fee, etc.), deadline date/time of the acceptance of the order making, and the like has been registered (stored); and the like. Therefore, an example of tables regarding the embodiment is shown in FIG. 18.

### Storage Information of the Order Taking Server 101 in the Fourth Embodiment Comparison with FIG. 3

In FIG. 18, reference numeral 1801 denotes a customer table for registering information necessary upon registration of the customer who joins the order taking system, that is, the name of customer, an ID that is peculiar to the customer (customer ID), an address, and a collection destination (place of collection for recycling). This table is similar to that described in FIG. 3.

Reference numeral 1803 denotes a collection history table in which a collection history of the collected collection items have been registered in association with the customer IDs.

Reference numeral 1805 denotes a collection area table in which the places of collection and the areas of collection have been registered in association with each other. This table has a function similar to that described in FIG. 3, and the area of collection is determined in correspondence to the delivery destination (place of collection) of the truck which has been designated from the order making terminal 103 through a predetermined communication line. This area of collection is used, for example, when a delivery schedule is formed or the like.

Reference numeral 1807 denotes a collection date table in which the date of collection of the collection item and the deadline have been defined. As for the deadline, for example, a date or a time zone that is predetermined period before the date of collection is automatically computed by the order taking server 101.

Reference numeral 1809 denotes an order table for registering (storing) the collection items ordered (whose collection for recycling has been requested) from the terminal apparatus 103 through the predetermined communication line, the number of collection items, and the date of collection designated by the customer. Those information has been registered in association with the customer IDs and managed every customer by the order taking server 101.

Reference numeral 1811 denotes a collection item info (information) table in which information such as names, sizes, and the like of the collection items corresponding to the collection item IDs has been registered in association with each other. It is not always necessary to make one collection item ID correspond to one collection item. For example, even in case of collection items with the same mechanical structure, if the colors of the main bodies are different, the different collection item ID can be also allocated every different color.

Reference numeral 1813 denotes a service content table for registering order taking conditions (service contents) for the order making for collection for recycling. Besides those information, delivery ability information and the like of the collector have been registered in the database.

### Comparison Between FIG. 4 and the Fourth Embodiment

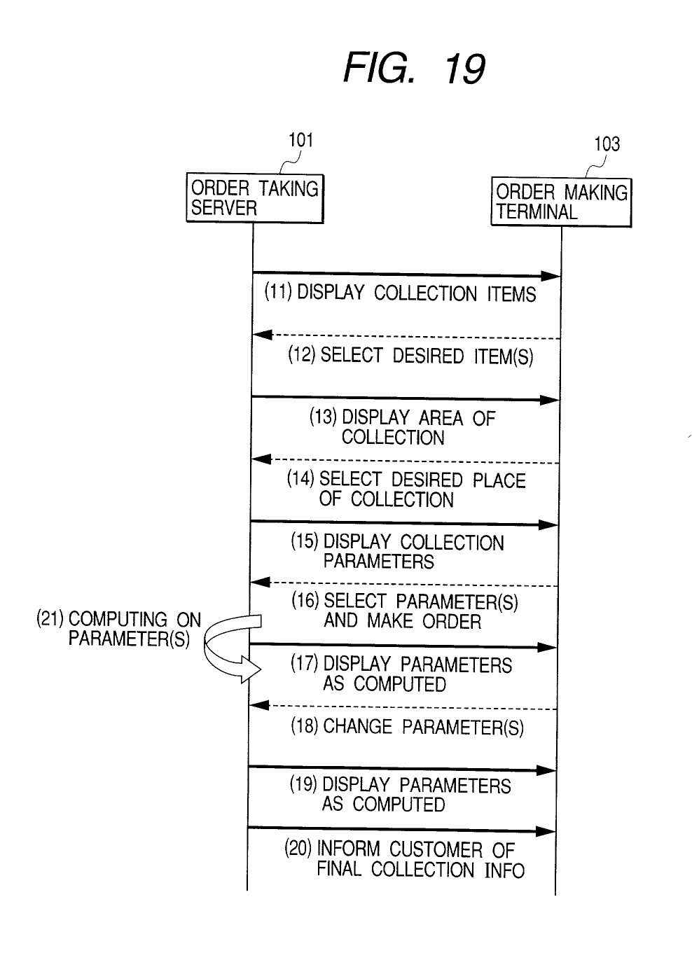

The information which is transferred between the order taking server 101 and order making terminal 103 in the fourth embodiment and the system operation will now be described with reference to FIGS. 4 and 19. In a manner similar to those described in the first embodiment, it is assumed that each of processes which will be described hereinbelow is realized by a method whereby the CPU provided for each of the order taking server 101 or the order making terminals 103 executes the process based on program codes stored in nonvolatile storage unit.

FIG. 19 shows processes which are fundamentally similar to those in the first embodiment and relates to a case where the information regarding the collection for recycling of the items is applied to request information which is transmitted from the order making terminal 103 to the order taking server 101.

In FIG. 4, the form such that the place of delivery of the article is designated from the order making terminal 103 to the order taking server 101 through the communication line has been described. However, even in the description in FIG. 19, there is a feature common to that in FIG. 4 with respect to a point that the truck is run to the place based on the designated request information from the order making terminal 103.

Explanation will now be made while making the process in each step in FIG. 4 correspond to the processes in the fourth embodiment (FIG. 19) hereinbelow.

### Correspondence Between Steps (1) and (2)

First, in the case where steps (1) and (2) in FIG. 4 are applied to the embodiment (steps (11) and (12)), as for items, the collection items (articles which are collected for recycling) are set to targets in each of “display items” and “select desired item(s)” in FIG. 4.

In this instance, although display picture plane information which is transmitted from the order taking server 101 to the order making terminal 103 corresponds to that in FIG. 5, as a selection of the collection items, for example, the method of selecting “printer supplies” described in the first embodiment corresponds to the embodiment. That is, the collection items are determined by using the display picture plane shown in FIG. 5 and they correspond to, for example, 509 in FIG. 5. Since the other details are similar to the method described in the first embodiment, their description is omitted here.

The display picture plane 601 in FIG. 6 can be also applied to the embodiment. A picture plane in which the article names (collection item names) described in FIG. 5 is displayed on the display portion 611.

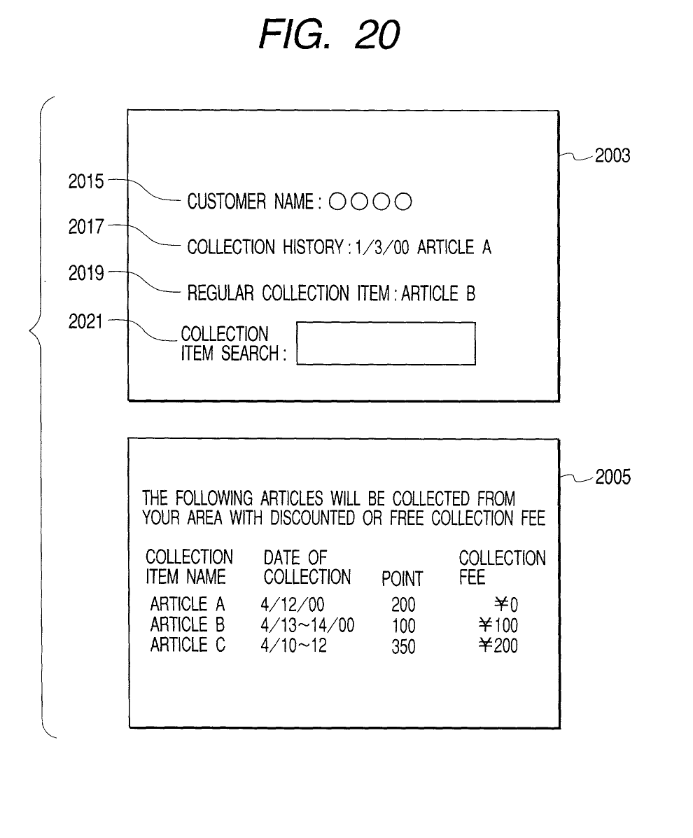

When the ID allocated to each customer is inputted to the portion corresponding to the input portion 613 in FIG. 6, the display picture planes corresponding to 603 and 605 are transmitted from the order taking server to the order making terminal 103 and displayed on the display portion of the order making terminal 103. FIG. 20 shows a display state in this instance. The details corresponding to each item are similar to those in FIG. 6. A method similar to that described by using FIG. 6 is realized by substituting “collection item” for “article” in FIG. 6 and substituting “collection history” and “regular collection item” for “purchase history” and “regular purchase article” in FIG. 6, respectively. Although “recommended for customers this address/area” shown in FIG. 6 is not displayed in FIG. 20, for example, in case of collecting the collection items every kind, it is also presumed that collection items of large additional services (the points in the fourth embodiment) are displayed as recommended items in FIG. 20.

### Correspondence to Step (3)

A method whereby the set picture plane information for designating the area of collection is transmitted from the order taking server 101 to the order making terminal 103 in step (13) is similar to the contents described by using FIG. 7 in the first embodiment, its description is omitted here.

### Correspondence to Step (4)

In the case where step (4) in FIG. 4 is applied to the embodiment (step (14)), subsequently, information for specifying the place of collection of the collection items is transmitted from the terminal 103 to the order taking server 101. For example, by applying the arrengement of FIG. 7 as a way of making the order taking server 101 set the place of collection, its object is accomplished. That is, it is presumed that the collection item (collection item search in FIG. 20) is made to correspond to the article A in FIG. 7 and the details of the collection item are applied to the details of the article.

In case of allowing the order taking server 101 to recognize the designated place of collection, as another form, for example, when a log-in is performed from the order making terminal 103 to the order taking server 101 through the predetermined communication line, if the area of collection is automatically determined from the customer address (1801 in FIG. 18) or place of collection (1801 in FIG. 18) which is specified in correspondence to the customer ID recognized by the order taking server 101, a working load on the customer in step (14) can be reduced.

### Correspondence to Step (5)

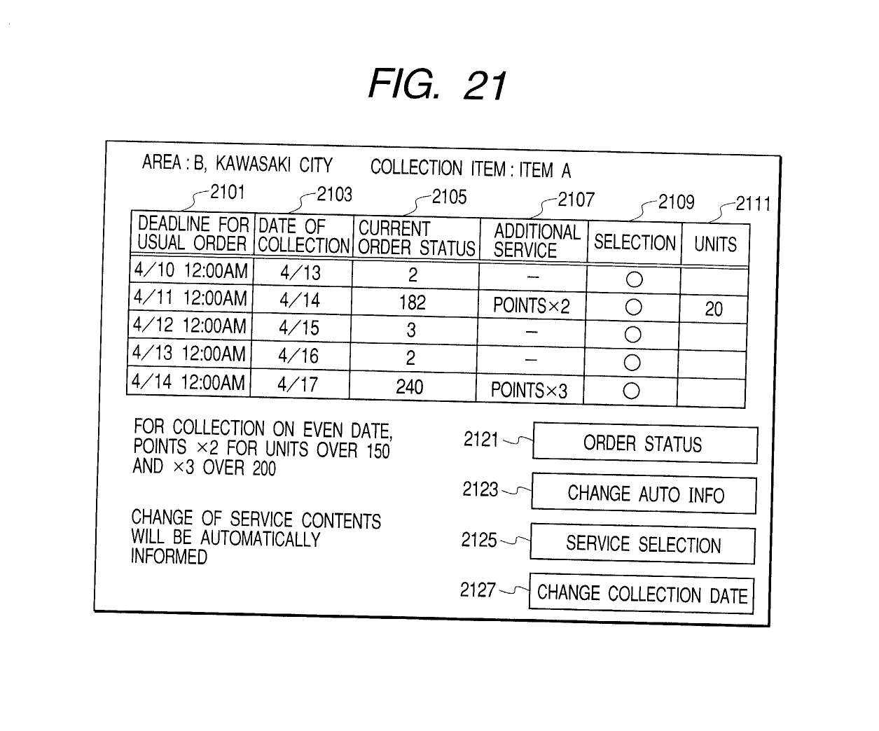

In step (15), display information such that a list of collection information which is specified to the area of collection that is specified from the place of collection in accordance with step (14) is transmitted from the order taking server 101 to the order making terminal 103. At this time, the collection information includes items such as date of collection, deadline for collecting request (order making), current order status (the total number of ordered collection items), additional service, and the like. In the embodiment, at this time, it is presumed to apply FIG. 8 to the display picture plane information which is provided (transmitted) from the order taking server 101 to the order making terminal 103. FIG. 21 shows a state of this application. The following points different from FIG. 8 can be mentioned: that is, a point that the collection item is applied to the article; a point that the date of collection is applied to the date of delivery; and a point that although the discount rate is displayed in FIG. 8 with respect to the additional service, collection points are displayed in FIG. 21. These points are managed for each user in the order taking server 101, and may used to get collection fee discount or purchase fee discount, for example.

Reference numeral 2121 denotes a collecting request status graphics button for displaying a current collecting request status 2105 by a bar graph. By notifying the order taking server 101 of depression information of this button, a graph of a graphic diagram similar to that described in FIG. 12 in the first embodiment is displayed on the display portion of the order making terminal 103.

Reference numeral 2123 denotes a change auto info button for allowing the customer to change an automatic notifying format. Although the details regarding the change auto info button 2123 are similar to those of the contents described above, explanation will be further made in detail hereinlater in the embodiment.

Reference numeral 2125 denotes a service selection button for displaying a service designation automatic selection picture plane. In this button, it is presumed that FIG. 13 described in the first embodiment is applied to the embodiment. The embodiment takes a form such that the customer inputs or selects a desired collection date range and desired service contents (for example, collection points of three times or the like) onto the picture plane of FIG. 13. In accordance with the information transmitted to the order taking server 101 in response to the input, the order taking server provides information such as date of collection and the like according to the desire of the customer to the order making terminal 103 in a manner similar to the first embodiment. Even in the case where the requested date of collection, conditions, and the like according to the desire of the customer do not exist, a method of providing services which are close to the services which the customer desires is similar to that in the first embodiment. Therefore, its detailed description is omitted.

Reference numeral 2127 denotes a change collection date button for changing the date of collection of the collection item which has already been ordered by the customer (day when the truck is run toward the place of collection) later.

The order taking server 101 displays a situation of a certain specific area of collection including the place of collection requested by the customer as shown in FIG. 21 on the basis of the collection item delivery place data of the customer, the base point data of the collector, the size/weight data of the collection item, and the like which are included in the database shown in FIG. 18 and stored in the apparatus itself. A list table regarding the current collecting request status and the order taking conditions with respect to the collection items is displayed on this picture plane. However, if only the deadline for usual order in which the additional services (providing compensation) such as collection points and the like are set to the conditions which are advantageous to the customer is displayed among the items shown in the list in FIG. 21 or if the additional services are rearranged in order from the more advantageous service, there will be obtained an effect such that the customer can easily understand the display picture plane in a manner similar to the first embodiment, an effect of promoting the concentration of the collection services on a certain month/day, and the like.

In the embodiment, as a method whereby only the deadline for usual order (collection request deadline) in which the advantageous conditions are set in the additional services in the collecting request is displayed on the order making terminal 103, it is presumed to apply FIG. 9 in the first embodiment, and as a method whereby the list obtained by rearranging the additional services in order from the advantageous service is displayed on the order making terminal 103, it is presumed to apply FIG. 10 in the first embodiment.

Returning to the description of FIG. 21, reference numeral 2101 denotes a deadline for usual order display column for displaying a usual order, that is, the deadline for the order making for the collection item. Reference numeral 2103 denotes a date of collection display column for displaying the date of collection of the collection items A corresponding to the deadline. Reference numeral 2105 denotes the collecting request status display column for displaying the current request status of the collection items A (the total number of collection items whose collection has been requested). Reference numeral 2107 denotes an additional service display column for the customer in the case where the collection items A were ordered; 2109 indicates a date of collection selection button; and 2111 shows a units input column for inputting the number of collection items which are ordered.

### Correspondence to Step (6)

When the customer executes an order making process, he depresses the selection button 2109 corresponding to the desired date of collection. After the customer set the units input column 2111 serving as a parameter which can be changed to a mode in which data can be inputted, he inputs the number of collection items A to be collected. Information based on such an input is transmitted from the order making terminal 103 to the order taking server 101 through the predetermined communication line (step (16) or (18)). The order taking server 101 which received the transmitted information automatically computes a change in service contents on the basis of the information regarding the date of collection and the number of collection items which was transmitted from the order making terminal 103 to the order taking server 101 in response to an instruction from the customer (step (21)).

Also in the embodiment, in a manner similar to the first embodiment, the service contents for the order making for the collection items are determined by comparing the total number of specific collection items which are collected on the specific date, that is, the order status of the collection items with a predetermined standard value. As a result of the comparison, if the total number of specific collection items which are collected on the specific date exceeds the predetermined standard value, the service contents change to the contents which are more advantageous to the customer. By more finely setting a plurality of standard values for changing the service contents, the service contents can be also changed step by step.

Processes in the case where steps (6) to (9) in FIG. 4 are applied to the embodiment (steps (16) to (19)) will now be explained further specifically.

In the example of FIG. 21, when the number of collection items A whose collection was requested on even date exceeds 150, the service such that the collection points are doubled (×2) for the collecting request of the collection items A is executed, and when it exceeds 200, the service such that the collection points are tripled (×3) for the collecting request of the collection items A is executed. Therefore, in this example, if the date of collection is designated to April 14 and 20 collection items A are ordered, the value in the order status display column 805 is changed to 202 by adding 20 to 182 by the automatic computation of the server. Therefore, since the total number of collection items A exceeds 200, the value in the additional service display column 807 is changed from “collection points×2” to “collection points×3”. Thus, the service to provide the collection points ×3 is given to all of the customers who ordered the collection items A (collecting request) by setting the date of collection to April 14. Naturally, the computation of change of the collection points described here can be also changed by a collecting request from another terminal apparatus 103 to the order taking server 101.

In step (17) or (19), the contents of the new order status and the additional services which were automatically computed by the order taking server 101 are displayed again on the order picture plane (corresponding to steps (7) and (9) in FIG. 4).

By applying the points in response to the collecting request as mentioned above, the collection can be further promoted to the customer. By setting the date of collection whose collection points are set to the higher points, the requested collection dates of the customer can be concentrated. On the collector side, the more efficient collecting work can be executed. Although FIG. 20 has been described with respect to the collecting request corresponding to the specific collection items (collection items A), it is also presumed in the embodiment to apply FIG. 20 to a form of the transportation route area of the truck (delivery car) and the requested collection date (collection time) without distinguishing the kinds of collection items or a form such that a plurality of kinds of collection items are set to the targets.

### Correspondence to Steps (7), (9), and (10)

A method whereby when the order making conditions such as collecting conditions or the like are changed in the fourth embodiment, the order making terminal 103 is automatically notified of it by using E-mail or the like will now be described. It corresponds to the further detailed process of the order taking server 101 in step (17) or (19) in FIG. 19. Although the whole process can be described by making FIG. 8 correspond to FIG. 21 in the embodiment, explanation will be further made by using FIG. 21 for the purpose of further easily understanding.

The customer can change the automatic notifying format from the order making terminal 103 by depressing the change auto info button 2123 on the order picture plane. That is, in accordance with the automatic notifying format which can be made different every customer, which will be explained hereinlater, the order taking server 101 notifies the terminal apparatus which is used by each customer. This notification corresponds to the processes of the order taking server 101 in steps (17), (19), and (20) in FIG. 19.

After depression of the change auto info button 2123, the order taking server 101 displays options for automatic notification onto the screen of the customer, for example, displays options regarding the notifying format such as automatic notification of every change in service contents, automatic notification which is executed only when the collection points change by a predetermined value or more, automatic notification with respect to a change in providing compensation (the collection fee is made free or the like) other than the collection points or the providing of a new compensation, notification in the case where a more advantageous condition (collection points) occurs on another date of collection, non-notification of the service contents, non-notification regarding the information just before the deadline, non-notification of a final deadline, and the like. The customer selects one or more of the plurality of options, thereby applying for a change in automatic notifying format. The order taking server 101 which received the information regarding the change in automatic notification changes the automatic notifying format for the customer on the basis of this information. It is assumed that the set picture plane information of the options corresponds to that the display information is transmitted from the order taking server to the order making terminal 103 in accordance with a set picture plane request from the order making terminal 103 to the order taking server 101.

Also in the embodiment, in a manner similar to the first embodiment, it is assumed that the order making for addition of the collection or the new order making by the customer can be accepted until the deadline date/time for usual order. The order taking server 101 makes the order for collection and determines the order taking conditions on the deadline.

The order taking can be also closed even before the deadline for order taking. For example, before the start of the order taking, the order taking server 101 preliminarily determines the full number of persons for order making in consideration of the range where the collecting work can be accomplished. The order taking can be also closed when the number of order making persons is equal to the full number of persons.

The date of collection which has already been ordered can be also changed. By depressing the change collection date button 2127, only the information regarding the date of collection of the relevant customer is displayed in the list on the order picture plane. Subsequently, by depressing the selection button 2109, the date displayed in the date of collection display column can be corrected. The customer can change the date of collection by correcting the displayed date.

Such a change in order contents by the customer can be performed until the deadline date/time for usual order. The reception of the change information of the order making contents is finished on the deadline. Even after the deadline date/time for usual order, it is also presumed to accept a new order for collection for a predetermined period of time by adding a condition such that the order making contents cannot be changed or the like.

The processes in steps (7), (9), and (10) in FIG. 4 or steps (17), (19), and (20) for the specific order making terminal 103 which are executed by the order taking server 101 and have been described above are executed in correspondence to steps (16) and (18) which are executed by each of a plurality of order making terminal apparatuses. By using E-mail, for example, the order taking server 101 notifies each order making terminal of the service content (for example, the discount rate or service points) which is changed in accordance with the order making process (corresponding to the collecting request in the fourth embodiment) of each of the plurality of terminal apparatuses for the same area in accordance with the automatic notifying format of each order making terminal as described above.

As also described above in the first embodiment, the process of the order taking server such that after the acceptance of the collection on April 14 was closed at 12:00 on April 11, the order taking server 101 notifies a plurality of order making terminal apparatuses is presumed also in the fourth embodiment. The order making terminal which is used by the customer is notified of a notification display (notification display regarding the collection similar to that in FIG. 21) as shown in FIG. 11. A message indicative of the presence of a possibility that if the date of collection is changed to April 14, a benefit is given to the customer who desires the collection on a date other than April 14 is shown. The collection date information before and after the date of collection as a target is also included in the report contents just before the deadline.

“Place of collection” in 1801 and “area of collection” in 1805 in FIG. 18 correspond to the acceptance of the collection on April 14 which was closed at 12:00 on April 11 in this instance. In a manner similar to FIG. 11, the order taking server 101 notifies the customers (order making terminals) as targets whose “places of collection” or “areas of collection” are the same or close. Therefore, a wasteful communication traffic (overflow of information due to the notification) can be prevented and advertisement for efficiently running the trucks can be realized. Further, for the customer, since such information is a notice for his own delivery area, he can efficiently obtain useful information. Naturally, the invention regarding FIGS. 14 and 15 described in the first embodiment can be also applied to the embodiment and it is assumed that its detailed description is similar to that in the first embodiment. Although FIG. 14 has been described on the assumption that the order taking server 101 performs the computation of the delivery schedule, in a form such that the deliverer has previously been decided, a form such that the information stored in the server as shown in FIG. 8 or 21 is transmitted to the terminal apparatus used by the deliverer through a predetermined communication line and the terminal apparatus on the deliverer side is allowed to execute a computation is also presumed in the invention. In this instance, a form such that the information which has properly been decided by the deliverer side is allocated as information of “area of collection” or the like shown in FIG. 3 or 18 and managed (stored) by the order taking server is presumed. In case of using such a form, a system such that “area of collection” can be registered into the order taking server 101 through a predetermined communication line from the terminal apparatus used by the deliverer side is considered. The contents shown in FIGS. 4 to 14 or 19 to 21 are also processed by the order taking server 101 so as to obtain the display information based on the information of “area of collection” mentioned above.

The inventions in the second and third embodiments can be also obviously applied to the fourth embodiment. In the case where the second embodiment is applied to the embodiment, the information in the collection item information table described in FIG. 18 is used, and the processes of the order taking server are executed so that the display picture plane regarding the collection items as shown in FIG. 16 can be displayed on the display portion of the order making terminal.

In the embodiment, the CPU 201 in FIG. 2 corresponds to the means for computing and deciding the additional services. Besides the above forms, the following forms can be also embodied.

A well-known collecting method can be used to display the information provided to the order making terminal 103 from the order taking server 101 onto the display portion of the order making terminal 103.

For example, in the case where the communication network in FIG. 1 is the Internet, a browser for displaying the HTML document is mounted in the order making terminal 103.

The HTML document for displaying the foregoing picture planes onto the order making terminal 103 side is preserved in the order taking server 101. It is desirable to prepare a communicating program (called a WEB server) for receiving the information inputted from the order making terminal 103 and a program (gateway program) for executing the foregoing information processes by the received information. Further, the invention is not limited to the browser for displaying the HTML document but a browser for browsing Internet information such as an XML browser or the like can be also applied.

A database server for executing only processes regarding the database can be also provided separately from the order taking server 101.

Although the preferred embodiments of the present invention have been described above, the invention is not limited to only those embodiments but many variations and modifications can be also embodied. For example, the system can be used for an order for receiving the collection of expendable supplies for recycling (toner cartridge of a printer and the like) of the articles. In the case where the same performance, exhibition, or the like is performed for a predetermined period of time, if the user wants to concentrate attendances on a specific date or to flatten the number of attendances, the invention can be used as a system for receiving reservations for admission tickets whose dates are designated.

### Specific Examples of Articles and Expendable Supplies

As specific examples of the articles in the embodiment, a copying apparatus, a facsimile apparatus, a hybrid apparatus of a copying apparatus and a facsimile apparatus, a scanner, an ink jet printer, and the like can be mentioned. As expendable supplies, toner, a toner cartridge, ink, an ink cartridge, a photosensitive drum, papers, an OHP sheet, and the like can be mentioned.

In the embodiments of the invention, although the case of providing the discount rate has been described as an example of the providing compensation which is given to the customer, the providing compensation to the customer is not limited to it. For example, it is possible to use a form such that points are given to the customer and an article/coupon ticket or the like is provided free of charge at the stage where predetermined points are accumulated or a form such that an article/coupon ticket or the like is provided to the customers selected by lot from the customers who ordered.

Naturally, the objects of the invention are accomplished by a method whereby a storage medium (or recording medium) in which program codes of software for realizing the functions of the first, second, and third embodiments have been recorded is supplied to a system or an apparatus, and a computer (or a CPU or an MPU) of the system or apparatus (for example, order taking server 101) reads out and executes the program codes stored in the storage medium. In this case, the program codes themselves read out from the storage medium realize the functions of the embodiments mentioned above, and the storage medium in which the program codes have been stored constructs the invention. The invention obviously contains not only a case where the functions of the embodiments mentioned above are realized by a method whereby the computer executes the read-out program codes but also a case where on the basis of instructions of the program codes, an operating system (OS) or the like which operates on the computer executes a part or all of the actual processes and the functions of the embodiments mentioned above are realized by those processes.

Further, the invention also incorporates a case where the program codes read out from the storage medium are written into a memory equipped for a function expansion card inserted into a computer or a function expansion unit connected to a computer and, after that, a CPU or the like equipped for the function expansion card or function expansion unit executes a part or all of the actual processes on the basis of instructions of the program codes and the functions of the embodiments mentioned above are realized by those processes.

In case of applying the invention to the storage medium, the sequence shown in FIG. 4 described before and/or program codes for making the data on the picture planes shown in FIGS. 5 to 13 or 15 to 17 are stored into the storage medium.

As described above, according to the invention, there is provided the order taking apparatus for receiving the order making for the articles or the collecting request of the collection items from a plurality of order making terminals, wherein the apparatus has the information processing means for setting the order taking conditions for the date of delivery or the date of collection and changing the order taking conditions in accordance with the order statuses from the plurality of order making terminals. Therefore, the order taking company can automatize the design of the services for the order making from the customers.

Since the information processing means changes the order taking conditions for the date of delivery or the date of collection to the order taking conditions which are advantageous to the customer in order to concentrate the dates of delivery of the articles or the dates of collection of the collection items, if various orders such as order making, collecting request, and the like are made on such a date of delivery or a date of collection, it is advantageous to the customer. Moreover, the number of articles which are delivered can be concentrated on the date of delivery or the number of collection items can be concentrated, so that a benefit is also given to the order taking company.

According to the invention, when the order taking conditions are changed, the communicating means transmits the changed order taking conditions to the terminal apparatus of the customer which made the order or the request for collection under the order taking conditions before the change. Therefore, the order taking company can not only notify the customer who has already ordered the articles or the customer who requests the collection of the collection items of a fact that the service was changed but also promote the customer to change the order (order making or collecting request) by presenting the services which are obtained after the change in service.

According to the invention, since the order for the articles is the order for delivery of predetermined articles or the order for collection of the expendable supplies of the articles for recycling, it is possible to expect that the concentration of the parcel delivery or collection services in accordance with a desire on the supplier side while allowing the customer to freely select or input the date/time of the parcel delivery of articles or the collection of expendable supplies for recycling. Since the dates/times of the parcel delivery or collection services are concentrated, the deliverer can consequently reduce the article circulating costs.

According to the invention, since the information processing means changes order taking conditions on the basis of the number of articles or expendable supplies which can be carried in a vehicle for delivering the articles or collecting the expendable supplies of the articles for recycling, the flatness of the parcel delivery services can be expected in accordance with the desire on the supplier side while allowing the customer to freely select or input the date/time of parcel delivery of the articles.

According to the invention, since the information processing means forms the list on the basis of the order status and the stored order taking conditions, the customer can select the date of delivery of the articles with reference to the order statuses of the other customers and the service contents in a table formats.

Since the information processing means forms the graph and table on the basis of the order status and the stored order taking conditions, the supplier of the articles can provide information which exerts an influence on the sense of sight to the customer.

According to the invention, since the information processing means forms and/or changes the order taking conditions with respect to each of a plurality of terminals, the services responsive to the order for the articles can be determined on the basis of the place of delivery or purchase history of the customer.

According to the invention, since the communicating means notifies only the order making terminal which made the order for articles before the order taking conditions are changed of a fact that the order taking conditions were changed, even if the contents of the services are changed after the articles were ordered, the customer can recognize the change of the discount rate without collating the order taking statuses.

According to the invention, since the communicating means receives the information regarding the change in notifying format from the order making terminal and the information processing means changes the notifying format for the order making terminal on the basis of the received information, the customer can receive the customized notification comprising only the necessary information in the information regarding the order taking status.

According to the invention, since the information processing means forms the information of the delivery work of the articles on the basis of the order status and the storage unit stores the information of the delivery work, the deliverer can reduce the labor for making the delivery schedule of the articles and the period of time and the costs which are required for making such a schedule.

According to the invention, as order taking conditions, since the providing compensation information which is advantageous to the customer has been predetermined, if the order taking company selects the order taking conditions in consideration of the convenience of order taking, the order taking conditions including the providing compensation information that is advantageous to the customer is consequently designed.

According to the invention, as order taking conditions, since the full number of order taking persons or an order taking quantity have been predetermined before the start of the order taking and the order taking is closed in accordance with the order taking conditions, the order taking work can be executed in accordance with the desired delivery Schedule on the order taking side.

What is claimed is:

1. An order taking apparatus for receiving orders for articles from a plurality of order making terminals, comprising:
information processing means for setting order taking conditions for a date of delivery and changing said order taking conditions in accordance with order statuses from said plurality of order making terminals; and
communicating means for communicating information with said order making terminals.

2. An apparatus according to claim 1, wherein said information processing means changes the order taking conditions for said date of delivery to order taking conditions which are advantageous to a customer in order to concentrate dates of delivery of the articles.

3. An apparatus according to claim 2, wherein when the order taking conditions are changed, said communicating means transmits said changed order taking conditions to a terminal apparatus of a customer who made the order under the order taking conditions obtained before the change.

4. An apparatus according to claim 1, wherein said information processing means forms delivery work schedule information for delivering said articles in accordance with said order statuses.

5. An order taking apparatus for receiving orders for articles from a plurality of order making terminals, comprising:
storage means for storing order taking conditions regarding the orders for the articles;
communicating means for communicating information with said order making terminals through a predetermined communication line; and
information processing means for changing the order taking conditions stored in said storage means in accordance with order statuses received from said plurality of order making terminals by said communicating means,
wherein said order taking conditions correspond to allocation dates of vehicles responsive to the orders for said articles.

6. An apparatus according to claim 5, wherein the order for said articles is a delivery of a predetermined article or a request for collection of expendable supplies for recycling which are used for said articles.

7. An apparatus according to claim 5, wherein said articles are used items and the order for said articles is a request for collection of said used items for recycling.

8. An apparatus according to claim 5, wherein said information processing means changes said order taking conditions on the basis of the number of said articles or expendable supplies which can be carried in a vehicle for delivering the articles or collecting said expendable supplies of said articles for recycling.

9. An apparatus according to claim 5, wherein said information processing means forms and/or changes the order taking conditions with respect to each of said plurality of terminals.

10. An apparatus according to claim 9, wherein said communicating means notifies only the order making terminal which ordered the articles before the order taking conditions are changed of a fact that said order taking condition s were changed.

11. An apparatus according to claim 8, wherein as said order taking conditions, an order taking quantity based on a carrying capacity of said vehicle has been predetermined before the start of the order taking, and the order taking is closed in accordance with the order taking conditions.

12. An apparatus according to claim 6, wherein said expendable supplies include toner, a toner cartridge, expendable parts, and ink, and said expendable parts include at least a photosensitive drum and a photosensitive unit.

13. An order taking apparatus which can perform a bidirectional communication with a terminal apparatus through a predetermined communication line, comprising:
communicating means for transmitting collecting request conditions for allocation dates of vehicles for collecting expendable supplies for recycling which are used for an image forming apparatus to said terminal apparatus; and
information processing means for computing said collecting request conditions in accordance with request information of said expendable supplies which is requested from said terminal apparatus through said predetermined communication line.

14. An apparatus according to claim 13, further comprising storage means for storing area information for managing every area the collecting requests for recycling requested from a plurality of terminal apparatuses, and
wherein said information processing means computes said collecting request conditions on the basis of said area information stored in said storage means.

15. An apparatus according to claim 14, wherein said area information is transmitted from an information processing apparatus which is used by a deliverer for running said vehicles.

16. An apparatus according to claim 13, wherein said communicating means transmits the collecting request conditions which are changed by said information processing means in accordance with collecting requests for recycling from a plurality of terminal apparatuses to said plurality of terminal apparatuses according to area information.

17. An apparatus according to claim 13, wherein said collecting request conditions are privilege information for said terminal apparatus.

18. An order taking method of receiving orders for articles from a plurality of order making terminals, comprising the steps of:
setting order taking conditions for a date of delivery;
changing said order taking conditions in accordance with order statuses from said plurality of order making terminals; and
communicating information regarding order taking with said order making terminals.

19. A method according to claim 18, wherein in said changing step, the order taking conditions for said date of delivery are changed to order taking conditions which are advantageous to a customer in order to concentrate dates of delivery of said articles.

20. A method according to claim 18, wherein in said communicating step, when the order taking conditions are changed, said changed order taking conditions are transmitted to the order making terminal of a customer who made the order under the order taking conditions obtained before the change.

21. A method according to claim 18, further comprising a step of forming delivery work schedule information for delivering said articles on the basis of said order statuses.

22. An order taking method of receiving orders for articles from a plurality of order making terminals, comprising:
a storing step of storing order taking conditions regarding the orders for the articles;
a communicating step of providing the order taking conditions stored in said storing step to said order making terminals; and
a processing step of changing the order taking conditions stored in said storing step in accordance with statuses of the orders received from said plurality of order making terminals in said communicating step,
wherein said order taking conditions correspond to dates of allocation of vehicles responsive to the orders for said articles.

23. A method according to claim 22, wherein the order for said articles is a delivery of a predetermined article or a request for collection of expendable supplies for recycling which are used for said articles.

24. A method according to claim 22, wherein said articles are used items and the order for said articles is a request for collection of said used items for recycling.

25. A method according to claim 22, wherein in said processing step, said order taking conditions are changed on the basis of the number of said articles or expendable supplies which can be carried in a vehicle for delivering the articles or collecting said expendable supplies of said articles for recycling.

26. A method according to claim 22, wherein in said processing step, the order taking conditions are formed and/or changed with respect to each of said plurality of terminals.

27. A method according to claim 22, further comprising a notifying step of notifying only the order making terminal which ordered the articles before the order taking conditions are changed of said order taking conditions changed in said processing step.

28. A method according to claim 25, wherein as said order taking conditions, the number of order taking persons based on a carrying capacity of said vehicle has been predetermined before the start of the order taking, and the order taking is closed in accordance with the order taking conditions.

29. A method according to claim 23, wherein said expendable supplies include toner, a toner cartridge, expendable parts, and ink, and said expendable parts include at least a photosensitive drum and a photosensitive unit.

30. An order taking method which is executed by a bidirectional communication with a terminal apparatus through a predetermined communication line, comprising:
a communicating step of transmitting collecting request conditions for allocation dates of vehicles for collecting expendable supplies for recycling which are used for an image forming apparatus to said terminal apparatus; and
a processing step of computing said collecting request conditions in accordance with request information of said expendable supplies which is requested from said terminal apparatus through said predetermined communication line.

31. A method according to claim 30, further comprising a storing step of storing area information for managing every area the collecting requests for recycling requested from a plurality of terminal apparatuses, and
wherein in said processing step, said collecting request conditions based on said area information stored in said storing step are computed.

32. A method according to claim 31, wherein said area information is transmitted from an information processing apparatus which is used by a deliverer for running said vehicles.

33. A method according to claim 30, wherein in said communicating step, the collecting request conditions which are changed in said processing step in accordance with collecting requests for recycling from a plurality of terminal apparatuses are transmitted to said plurality of terminal apparatuses according to area information.

34. A method according to claim 30, wherein said collecting request conditions are privileges for said terminal apparatus.

35. A computer-readable storage medium which stores a program that is executed in an order taking apparatus for receiving orders for articles from a plurality of order making terminals, wherein said program comprises the steps of:
setting order taking conditions for a date of delivery;
changing said order taking conditions in accordance with order statuses from said plurality of order making terminals; and
communicating information regarding order taking with said order making terminals.

36. A computer-readable storage medium which stores a program that is executed in an order taking apparatus for receiving orders for articles from a plurality of order making terminals, wherein said program comprises:
a storing step of storing order taking conditions regarding the orders for the articles;
a communicating step of providing the order taking conditions stored in said storing step to said order making terminals; and
a processing step of changing the order taking conditions in accordance with statuses of the orders received from said plurality of order making terminals in said communicating step, and
said order taking conditions correspond to allocation dates of vehicles responsive to the orders for said articles.

37. A computer-readable storage medium which stores a program that is executed in an order taking apparatus which can perform a bidirectional communication with a terminal apparatus through a predetermined communication line, wherein said program comprises:
a communicating step of transmitting collecting request conditions for allocation dates of vehicles for collecting expendable supplies for recycling which are used for an image forming apparatus to said terminal apparatus; and
a processing step of computing said collecting request conditions in accordance with request information of said expendable supplies which is requested from said terminal apparatus through said predetermined communication line.

38. An order taking program that is executed in an order taking apparatus for receiving orders for articles from a plurality of order making terminals, comprising the steps of:
setting order taking conditions for a date of delivery;
changing said order taking conditions in accordance with order statuses from said plurality of order making terminals; and
communicating information regarding order taking with said order making terminals.

39. An order taking program that is executed in an order taking apparatus for receiving orders for articles from a plurality of order making terminals, comprising:
a storing step of storing order taking conditions regarding the orders for the articles;
a communicating step of providing the order taking conditions stored in said storing step to said order making terminals; and
a processing step of changing the order taking conditions stored in said storing step in accordance with statuses of the orders received from said plurality of order making terminals in said communicating step,
wherein said order taking conditions correspond to allocation dates of vehicles responsive to the orders for said articles.

40. An order taking program that is executed in an order taking apparatus which receives orders of articles from a plurality of order making terminals, comprising:
a communicating step of transmitting collecting request conditions for allocation dates of vehicles for collecting expendable supplies for recycling which are used for an image forming apparatus to said order making terminal; and
a processing step of computing said collecting request conditions in accordance with request information of said expendable supplies which is requested from said order making terminal through a predetermined communication line.
